(19) United States
(12) Patent Application Publication
(10) Pub. No.: US 2026/0156317 A1
(43) Pub. Date: Jun. 4, 2026

(54) TRANSFERRING AN IMMERSIVE IMAGERY ENVIRONMENT FOR DISPLAYING MEDIA CONTENT ON AN EXTENDED REALITY DEVICE

(71) Applicant: GOOGLE LLC, Mountain View, CA (US)

(72) Inventors: Katherine Faith Erdman, Mountain View, CA (US); Yusuke Sato, Sunnyvale, CA (US); Marianne Batista de Abreu, San Francisco, CA (US); Yizhi Zhao, Los Altos, CA (US)

(21) Appl. No.: 19/406,511

(22) Filed: Dec. 2, 2025

Related U.S. Application Data
(60) Provisional application No. 63/727,073, filed on Dec. 2, 2024.

(51) Int. Cl. H04N 21/431; H04N 21/414; H04N 21/437; H04N 21/472; H04N 21/6587

(52) U.S. Cl. CPC H04N 21/4312; H04N 21/41407; H04N 21/437; H04N 21/472; H04N 21/6587

(57) ABSTRACT

According to an aspect, a method includes rendering a user interface on an extended reality device, the user interface identifying a media item for playback using a streaming application, in response to selection of the media item for playback, initiating a display of immersive imagery related to the media item on the extended reality device, and transmitting a request to the streaming application. The request includes at least one parameter about the immersive imagery that causes the streaming application to render a display panel within the immersive imagery using the at least one parameter, the display panel displaying content of the media item.

### CROSS-REFERENCE TO RELATED APPLICATION

This application claims priority to U.S. Provisional Patent Application No. 63/727,073, filed on Dec. 2, 2024, entitled “SEARCH IN RESPONSE TO SELECTION OF VISUAL CONTENT”, the disclosure of which is incorporated by reference herein in its entirety.

### BACKGROUND

An extended reality device provides an immersive experience such as a three-dimensional (3D) space that simulates a real-world, a virtual setting, or a combination of both. In some examples, in the 3D space, the extended reality device may display a user interface displaying two-dimensional (2D) media content such as streaming a movie or watching a video file.

### SUMMARY

This disclosure describes systems and methods for enhancing a user's media viewing experience on an extended reality (XR) device, such as a virtual reality (VR) headset. The technology automatically generates a 360-degree, immersive background environment that is thematically related to the content being consumed (e.g., viewed and/or listened to). For example, a user watching a movie set in a jungle could be virtually surrounded by a panoramic jungle scene instead of a generic virtual theater. If they are watching a documentary about ancient Rome, the background could transform into a 3D reconstruction of the Colosseum. With respect to audio data, a user may be listening to the soundscape of rain and then receive a panoramic image associated with a rainy scene. Users can also create or modify these environments using text or voice commands, such as asking for a “sunny beach at sunset” to create a personalized virtual space.

In some examples, this immersive environment can be seamlessly transferred between applications. For instance, if a user selects a movie from a central media guide application that creates a themed background, that same background will persist when a separate streaming service application opens to play the movie, providing a continuous and uninterrupted experience. The technology also allows for creating and sharing 3D scans of real-world places, enabling users to virtually visit a friend's room or explore a scanned model of a local landmark.

This disclosure relates to a system that generates immersive imagery based on metadata and/or user prompts for display in an immersive environment of a computing device (e.g., an extended reality device). The immersive imagery may be a panoramic image or a three-dimensional (3D) reconstructed scene. In some examples, the immersive imagery is themed to a media item (e.g., a movie, video, etc.) and displayed as a background of a display panel that displays two-dimensional (2D) content of the media item. For example, the user can watch a program while being immersed in an environment that is themed to the content currently being played. The system provides one or more technical benefits of generating panoramic images (e.g., 360-degree panoramic images) and/or three-dimensional (3D) reconstructed scenes by reducing the amount of computing resources, reducing the time required for image generation, and/or reducing the number of distortions or artifacts in an image. In some examples, the system enables an application (e.g., another application) to use (e.g., inherit) the immersive imagery by generating and transmitting a request (e.g., an operating system request, an intent, an intent request, etc.) to the application, where the request includes one or more parameters about immersive mode such as the curvature of the panel, a display panel size and/or location, and/or other parameters that enable the application to use the immersive imagery in a user interface or background of the application.

In some aspects, the techniques described herein relate to a method including: generating immersive imagery related to a media item of a media platform; rendering the immersive imagery on an extended reality device; and rendering a display panel in the immersive imagery, the display panel displaying content of the media item.

In some aspects, the techniques described herein relate to a non-transitory computer-readable medium storing executable instructions that when executed by at least one processor causes the at least one processor to execute operations, the operations including: generating immersive imagery related to a media item of a media platform; rendering the immersive imagery on an extended reality device; and rendering a display panel in the immersive imagery, the display panel displaying content of the media item.

In some aspects, the techniques described herein relate to an extended reality device including: at least one processor; and a non-transitory computer-readable medium storing executable instructions that cause the at least one processor to: generate immersive imagery related to a media item of a media platform; render the immersive imagery on an extended reality device; and render a display panel in the immersive imagery, the display panel displaying content of the media item.

In some aspects, the techniques described herein relate to a method including: rendering a user interface on an extended reality device, the user interface identifying a media item for playback using a streaming application; and in response to selection of the media item for playback: initiating a display of immersive imagery related to the media item on the extended reality device; and transmitting a request to the streaming application, the request including at least one parameter about the immersive imagery that causes the streaming application to render a display panel within the immersive imagery using the at least one parameter, the display panel displaying content of the media item.

In some aspects, the techniques described herein relate to a non-transitory computer-readable medium storing executable instructions that cause at least one processor to execute operations, the operations including: rendering a user interface on an extended reality device, the user interface identifying a media item for playback using a streaming application; and in response to selection of the media item for playback: initiating a display of immersive imagery related to the media item on the extended reality device; and transmitting a request to the streaming application, the request including at least one parameter about the immersive imagery that causes the streaming application to render a display panel within the immersive imagery using the at least one parameter, the display panel displaying content of the media item.

In some aspects, the techniques described herein relate to an extended reality device including: at least one processor; and a non-transitory computer-readable medium storing executable instructions that cause the at least one processor to: render a user interface on the extended reality device, the user interface identifying a media item for playback using a streaming application; and in response to selection of the media item for playback: initiate a display of immersive imagery related to the media item on the extended reality device; and transmit a request to the streaming application, the request including at least one parameter about the immersive imagery that causes the streaming application to render a display panel within the immersive imagery using the at least one parameter, the display panel displaying content of the media item.

The details of one or more implementations are set forth in the accompanying drawings and the description below. Other features will be apparent from the description and drawings, and from the claims.

### BRIEF DESCRIPTION OF THE DRAWINGS

FIG. 1A illustrates a system for generating immersive imagery for an extended reality device according to an aspect.

FIG. 1B illustrates an example of immersive imagery in relation to a display panel according to an aspect.

FIG. 1C illustrates an example of immersive imagery for a media item in a first view according to an aspect.

FIG. 1D illustrates an example of immersive imagery for a media item in a second view according to an aspect.

FIG. 1E illustrates examples of metadata for generating immersive imagery according to an aspect.

FIG. 1F illustrates examples of immersive imagery according to an aspect.

FIG. 1G illustrates an example of a visual effect applied to pass-through video according to an aspect.

FIG. 2 illustrates an example of an immersive imagery engine according to an aspect.

FIG. 3 illustrates an example of an immersive imagery engine according to another aspect.

FIG. 4 illustrates an example of an immersive imagery engine according to another aspect.

FIGS. 5A to 5C illustrate aspects of a scene extender model according to an aspect.

FIG. 6 illustrates an aspect of a scene extender model according to another aspect.

FIG. 7 illustrates an example of an immersive imagery engine according to another aspect.

FIG. 8 illustrates an example of an upsampler according to an aspect.

FIG. 9 illustrates an example of an immersive imagery engine according to another aspect.

FIG. 10 illustrates an example of an immersive imagery engine according to another aspect.

FIGS. 11A to 11E illustrate various aspects of a system for generating immersive imagery according to an aspect.

FIG. 12 illustrates a system of a media platform with an immersive imagery engine according to an aspect.

FIGS. 13A to 13C illustrate a system for enabling the inheriting of immersive imagery from one application to another application.

FIGS. 14A to 14F illustrate example user interfaces of the system of FIGS. 13A to 13C according to an aspect.

FIG. 15 illustrates a flowchart depicting example operations for generating and/or providing an immersive environment according to an aspect.

FIG. 16 illustrates a flowchart depicting example operations for generating and/or providing an immersive environment according to another aspect.

FIG. 17 illustrates a flowchart depicting example operations for generating and/or providing an immersive environment according to another aspect.

### DETAILED DESCRIPTION

In some conventional extended reality systems, there exists one or more technical problems in which devices are unable (or have difficulty) to generate immersive environments that are thematically aligned with content (e.g., media content) while satisfying quality, latency, and/or safety constraints. Existing systems may rely on static backgrounds, manually authored scenes, or pre-defined skyboxes that do not dynamically correspond to the metadata, visuals, or audio of the media item being consumed, thereby limiting immersion and requiring significant manual creation effort.

This disclosure provides a technical solution that generates immersive imagery based on metadata and/or user prompts for display in an immersive environment of a computing device (e.g., an extended reality device) in a manner that overcomes one or more technical problems present in conventional systems. The system provides one or more technical benefits of generating panoramic images (e.g., 360-degree panoramic images) and/or three-dimensional (3D) reconstructed scenes by reducing the amount of computing resources, reducing the time required for image generation, and/or reducing the number of distortions or artifacts in an image. In some examples, the system includes an immersive imagery engine configured to generate immersive imagery themed to a media item, and displays the immersive imagery, on an extended reality device, as background for a display panel (e.g., a video player window) that displays two-dimensional (2D) content of the media item.

In some examples, the immersive imagery includes a panoramic image with a wide field of view. In some examples, the field of view of the panoramic image is equal to or greater than 100 degrees. In some examples, the field of view of the panoramic image is greater than 180-degrees. In some examples, the immersive imagery includes a 360-degree skybox image. A 360-degree skybox image may be a panoramic image that surrounds the user's field of view, creating an immersive virtual environment. In some examples, a skybox image is a spherical view of a 2D image. In some examples, a skybox image is a panoramic image that is mapped onto the inside of a sphere. In some examples, the panoramic image includes (or uses) equirectangular projection or a cube map as an image format. As the user manipulates the extended reality device (e.g., rotating and/or titling the user's head), the panoramic image shifts accordingly, thereby giving the user the sensation of being within the scene represented by the immersive imagery.

The extended reality device may render a user interface of a host application (e.g., a media application, a streaming application, or a video-sharing application) and the user may select a media item for viewing. The media item may be video such as user-generated content or a program such as a movie, a television show, or a live broadcast or generally any type of video content. In some examples, the host application may provide a selectable control that enables the user to select an immersive mode for viewing the media item. In some examples, in response to selection of the immersive mode, the extended reality device displays the immersive imagery as background for a display panel (e.g., a video player window). The display panel displays the 2D content of the selected media item. In some examples, the display panel is displayed according to one or more immersive-environment attributes such as a curvature value indicating a curvature radius (e.g., radius value) of the display panel, a panel size (e.g., a height and/or width), and/or a panel placement parameter on a position (e.g., relative or fixed) of the display panel in the immersive environment, which may be set by the media application and/or adjustable by a user. The immersive imagery is generated based on the theme of the content the user is viewing (e.g. if the user has selected Star Wars for viewing, their extended reality environment may change to a planetary skybox image).

The immersive imagery may be generated to include one or more animated elements. For example, the scene depicted by the immersive imagery may include one or more animated elements that move or change over time. In other words, animated elements in the immersive imagery may refer to dynamic elements in the panoramic image that move or change over time (e.g., leaves moving on trees, birds flying overhead, movement of waves in the ocean, or stars can be animated to simulate their movement across the night sky, creating a sense of time and realism, clouds can be animated to drift across the sky, changing shape and density, rain, snow, fog, and other weather effects can be simulated to create immersive atmospheric conditions, intensity and direction of light can change over time, creating dynamic lighting effects, certain objects within the immersive imagery can be interactive, allowing users to manipulate them or trigger specific events such as another immersive imagery, including 3D scene content).

In some examples, the immersive imagery may be generated to include one or more virtual objects (e.g., a 3D model of a chair, couch, table, etc.) that the user can interact with (e.g., select, manipulate, move, trigger an action, etc.). In some examples, the immersive imagery includes a selectable element or object, (also referred to an interactive virtual object) which, when selected, displays another panoramic image or 3D reconstructed scene (e.g., embedded scenes within scenes, etc.).

In some examples, the system includes a dynamic hue engine configured to render a visual effect (e.g., at least partially around or fully around) the display panel (e.g., the video player window). In some examples, the visual effect includes a dynamic display of colored flares or haloes that change color in real-time to match the dominant hues in the playback content of the media item. In some examples, the visual effect is referred to as a dynamic hue screen extension. In some examples, the visual effect includes adaptive virtual color flares surrounding the display panel (e.g., the video player window) in which the media item is being viewed (“extended screen”). The virtual color flares may change based on the colors in the content (e.g., a gardening “how to” video may cause the dynamic hue engine to display adaptive green flares surrounding the display panel). The dynamic hue engine analyzes the color content of the video or image being played and then generates the visual effect around the media player. The visual effect may include the display of colored flares or halos that change color in real-time to match the dominant hues in the playback content.

In some examples, instead of displaying the immersive imagery on a display of the extended reality device, the extended reality device may enable the selection of an augmented reality (AR) mode, which passes through the user's surroundings. For example, in the AR mode, the extended reality device may display pass-through video of the user's surroundings in the extended reality environment, and the display panel may be positioned in the user's space in the extended reality environment. In some examples, the dynamic hue engine may adjust the hue of the user's passthrough surroundings to correspond to (e.g., match) the color themes of the content being displayed on the display panel. For example, if a user is watching a movie with a predominantly blue color scheme, the dynamic hue engine may cause the real-world environment to appear bluer. In some examples, the dynamic hue engine may analyze the video content being played to determine its dominant colors and overall color palette and perform color filtering on the device's display by filtering the light emitted by the display's pixels. The extended reality device includes a camera system configured to capture the user's surroundings. In some examples, the dynamic hue engine may use the color information from the video content to adjust the color of the images captured by the camera system.

In some examples, the extended reality device renders an interface to receive a user prompt (e.g., a natural language query for a prompt) to adjust the immersive imagery or to create a custom immersive imagery, which may include changing a portion or an aspect of the immersive imagery, generating new immersive imagery, and/or animating one or more elements in the immersive imagery and/or adding one or more virtual objects (or interactive virtual objects) (e.g., 3D maps of a physical object). For example, a user may submit a natural language query (e.g., via voice or text) to animate one or more elements of the immersive imagery (e.g., animate the leaves, enlarge the stars, make them brighter). In response to the user prompt (e.g., the natural language query), the immersive imagery engine may re-generate immersive imagery using the natural language query and the previous panoramic images. In other words, the immersive imagery engine may enable the generation of custom immersive imagery. In some examples, the custom immersive imagery may be saved by storing the custom immersive imagery in data storage, e.g., in association with a user account. In some examples, the user may share the custom immersive imagery with other users of extended reality devices.

In some examples, instead of the immersive imagery being themed to a particular media item (and then adjust the immersive imagery using a natural language prompt), the immersive imagery engine may generate immersive imagery for an interface (e.g., primary interface) of the extended reality device based on one or more user prompts (e.g., natural language prompts provided by a user). In some examples, the interface is an interface of the operating system of the extended reality device. In some examples, the interface includes an interface with a wide field of view (e.g., a 360-degree home skybox). A 360-degree home skybox is a virtual environment in which the user can access applications, widgets, and/or other functions. For example, a user may submit a natural language query (e.g., via voice or text), and, in response to the natural language query, the immersive imagery engine may generate immersive imagery based on the natural language query. For example, a user may enter the 360-degree home skybox, and, using natural language (e.g., voice or text prompt), the user asks to be taken to a tulip field in Amsterdam on a bright spring day. The user's 360 degree home skybox is then surrounded by vibrant tulips of every color against the backdrop of a bright blue sky. Later in the day, the user may submit a natural language prompt to change her skybox scene to a sand garden with natural earth tones. The user may submit additional natural language queries to adjust the immersive imagery, add animated elements, and/or virtual objects.

In some examples, the immersive imagery includes a 3D reconstructed scene representing a virtual-world scene or real-world scene. In some examples, the 3D reconstructed scene may be generated based on video and/or images of a real-world scene. In some examples, the camera system on the extended reality device may capture images and/or a video of the user's physical space, and the immersive imagery engine may generate a 3D reconstructed scene using the captured sensor data (e.g., the images and/or video), which can be displayed as the user's skybox. For example, the extended reality device may display the 3D reconstructed scene in an interface (e.g., 360 home skybox or a media viewing interface with a video media player). The use of 3D reconstructed scenes may allow a user to explore the scene from any angle, zoom in on specific details, and, in some examples, interact with one or more virtual objects within the scene. In some examples, the extended reality device may provide an interface for receiving one or more user prompts (e.g., natural language queries) to be used in prompts for adjusting the 3D reconstructed scene, including the changing of certain aspects of the scene and/or the addition or deletion of other objects. In some examples, the system may enable the storage of 3D reconstructed scenes, as well as the ability for the user to share their 3D reconstructed scenes with other users.

In some examples, the immersive imagery engine is associated with a database that stores a number of immersive imageries (e.g., pre-generated 3D reconstructed scenes and/or panoramic images or user-saved immersive imageries of various scenes), and the immersive imagery engine may search the database to identify one or more 3D reconstructed scenes or panoramic images that is responsive to a user's search. In response to selection of a particular 3D reconstructed scene or a panoramic image, the extended reality device may provide the 3D reconstructed scene or the panoramic image in the user's skybox for a particular interface such as a media viewing interface, a skybox home interface, or another interface of the operating system or an application executing on the operating system.

In some examples, the extended reality device may execute an application (e.g., a map application, or generally any type of application) that can provide satellite or street views or area views of the real world. In some examples, the application may operate in conjunction with the immersive imagery engine to transition into the 3D reconstructed scene (or sometimes referred to as a 3D reconstructed object or 3D object) from an area view or street view in the application. A street view may be a feature that provides 360-degree panoramic views at ground level of various locations. A user can “move” through the environment virtually, like walking or driving. An area view takes a step back and provides a broader, more contextual view. In an area view, a user can pan and zoom across the image. In some examples, a user may interact with an object in the area view or the street view, which then causes the application to render a 3D reconstructed scene (e.g., a 3D model of a restaurant so that the user can view the inside of the restaurant). In some examples, a business entity may use a user device to capture image(s) and/or video of their place, which causes the immersive imagery engine to generate a 3D reconstructed scene, which can be linked to their object in the application.

The immersive imagery engine may include one or more machine-learning (ML) models (e.g., generative models such as text-to-text generative models, text-to-image generative models, image-to-image generative models and/or multi-modality generative models) that can receive text, audio, and/or image in a prompt as an input, and generate text, audio, and/or an image as an output. In some examples, the immersive imagery engine may generate a panoramic image (e.g., a 360-degree image) from a text prompt or a prompt with text, image, and/or video. In some examples, the immersive imagery engine may include a 2D-to-360 image pipeline. The 2D-to-360 degree image pipeline may include a plurality of layers such as prompt engineering, base image generation, field of view extension, upsampling, and/or hue extension.

In some examples, the immersive imagery engine may generate an immersive imagery based on metadata. In some examples, the metadata may include textual data such as one or more portions of information from an entity page (e.g., title, poser/image, genre, release date/year, runtime/number of seasons, rating, description, plot summary, character descriptions, cast and crew, and/or list of characters, etc.), a resource locator, caption data (e.g., text version of the audio in a video or other media), and/or a description of a media item. In some examples, the metadata includes video, image, and/or audio samples from the media item. In some examples, the immersive imagery engine may generate immersive imagery based on a natural language query received via a prompt interface. In some examples, the immersive imagery generates the immersive imagery based on the user prompt (e.g., without the metadata). In some examples, the immersive imagery engine generates the immersive imagery based on the metadata, and the user can adjust the immersive imagery by submitting one or more user prompts.

In some examples, the immersive imagery engine may include (or communicate with) a generative model (e.g., a language model or a large language model). The immersive imagery engine may generate and send a prompt that includes the metadata or the natural language query, and the generative model receives the prompt as an input and generates a summary caption (e.g., a short summary) as an output. The summary caption may be a short phrase describing the theme of an image to be created. The immersive imagery engine may communicate with the same generative model or a different generative model to generate a base image (e.g., a 2D image) using the summary caption as an input. In some examples, instead of generating the summary caption, the immersive imagery engine may provide the prompt with the metadata or the user prompt (e.g. the natural language query) to the generative model, and the generative model generates the base image using the metadata or the natural language query.

In some examples, the immersive imagery engine includes a scene extender model configured to receive the base image and generate a larger panoramic image (e.g., a 360 degree panoramic image) from the base image. The scene extender model may include one or more ML models that extends the field of view of the base image to a larger image. In some examples, the scene extender model includes a captioner (e.g., a generative model) configured to generate a caption of the base image using the base image as an input. The scene extender model may generate a mask based on the base image. The scene extender model may feed input image, mask and the caption to an image generation model to generate an image with a size larger than the base image. A mask may be a binary or multi-channel digital image that spatially defines regions within an image for specific processing operations. The mask may operate as a filter to control which parts of an image are modified or preserved during the extension process. In some examples, the scene extender model uses embedding conditioning that enables generation of more images similar to the reference image (e.g., the base image or an immediate image from one of the out-painting stages).

In some examples, the immersive imagery engine includes an upsampler configured to upsample the panoramic image from the scene extended model to a higher resolution. In some examples, the upsampler includes one or more ML models (e.g., a diffusion model) to upsample an image to a higher resolution. In some examples, the immersive imagery engine includes a blending engine configured to blend aspects of the output image (e.g., blend edges of landscape using hue extension, and blend hue extension to back for full 360 panorama) to generate the final immersive imagery.

In some examples, the immersive imagery engine includes a scoring engine configured to generate a quality metric for the immersive imagery. The scoring model is configured to generate the quality metric (e.g., level of quality of the generated panorama image) based on one or more computable criteria. For example, the criteria may include prompt alignment (e.g., how well the generated image matches the prompt, which can be quantified using a CLIP score or a similar image-text similarity model), image fidelity (e.g., closeness to a ground truth 2D image), seam alignment (e.g., a measure of visual continuity calculated by analyzing pixel value differences across stitched image boundaries, i.e., a level of smooth and consistent blending of different parts of an image), and/or floor plane consistency. In some examples, the scoring model includes one or more ML models that are trained to generate a quality metric based on prompt alignment, image fidelity, and/or seam alignment. If the quality metric is equal to or greater than a threshold level, the immersive imagery engine may provide the immersive imagery for display on the extended reality device. In response to the quality metric being less than the threshold level, the immersive imagery engine may cause the extended reality device to activate the dynamic hue engine to provide a visual hue effect on video-pass through. For example, instead of providing the immersive imagery, the extended reality device may provide the pass-through video as a background for the display panel and activate the dynamic hue engine to adjust the hue of the user's passthrough surroundings to correspond to (e.g., match) the color themes of the content being displayed on the display panel. For example, if a user is watching a movie with a predominantly blue color scheme, the dynamic hue engine may cause the real-world environment to appear bluer.

In some examples, the host application on the extended reality device is a media aggregator application that aggregates media items across streaming platforms in a unified user interface. The selection of a media item from the media aggregator application causes the media aggregator application to launch a streaming application to play back the media item. In some examples, a media item available for selection in the media aggregator application (but streamed from the streaming application) has immersive imagery generated by the immersive imagery engine associated with the media aggregator application. In response to selection of the media item, in some examples, the media aggregator application may display a dialog that asks the user whether they wish to watch the media item in a themed cinema. In response to selection of a control that selects the themed cinema, the media aggregator application (e.g., application A) may transmit a request (e.g., an intent request) that enables the streaming application (e.g., application B) to inherit the immersive environment associated with the media aggregator application.

In some examples, in response to the selection of the control that selects the themed cinema, the media aggregator application may generate an activity that displays the immersive imagery on the display, and the media aggregator application (e.g., application A) transmits a request (also referred to as an inter-process request, an intent request, an intent, or simply a request) to the streaming application (e.g., application B). The request includes an inheritance parameter (e.g., an inherent flag), which, when set or activated, directs the system to maintain the immersive imagery for the new application (e.g., application B), which appears to inherit the previously set immersive imagery by application A. Also, the request may include one or more parameters that are used by application B to integrate the display panel into the immersive imagery. In some examples, the request includes a curvature value defining a curvature radius of the display panel, a panel size defining a size of the display panel, and/or a panel placement parameter defining a position of the display panel in the immersive imagery. In some examples, the request also includes a content identifier that identifies a location (e.g., a deep content link) of the media item within the streaming application (e.g., application B). The streaming application (e.g., application B) may use the information in the request to render the display panel in the immersive imagery, where the display panel displays the content (e.g., 2D content) of the media item. These and other features are further described with reference to the figures.

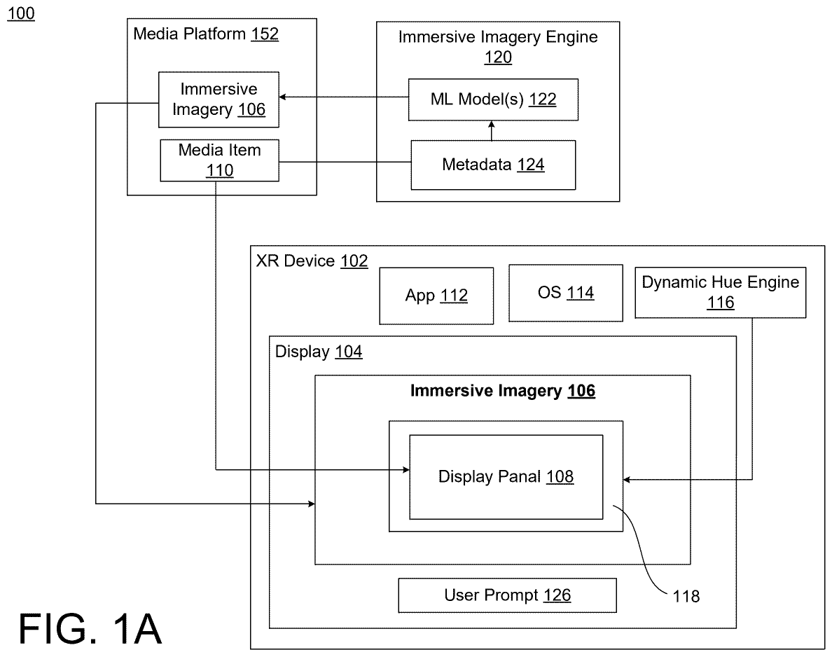

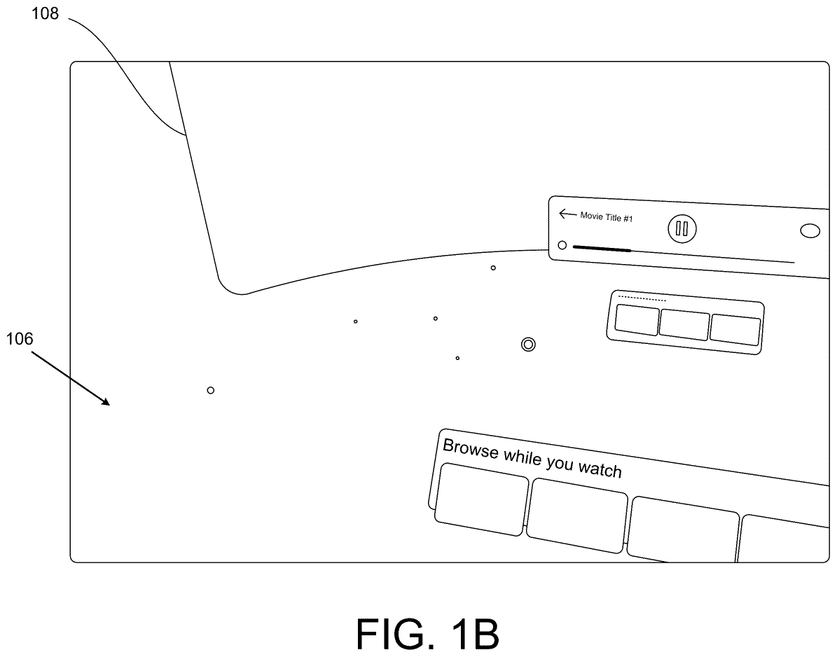

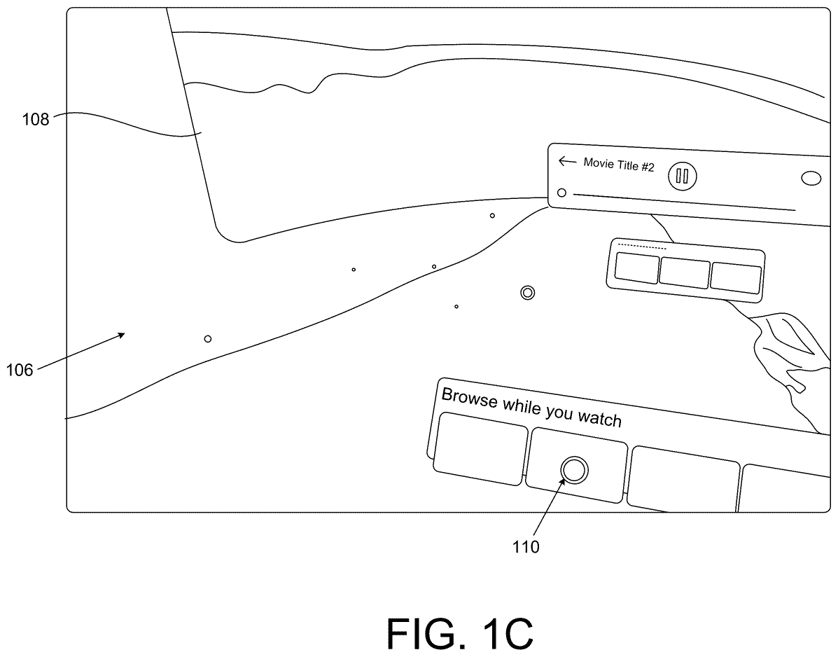

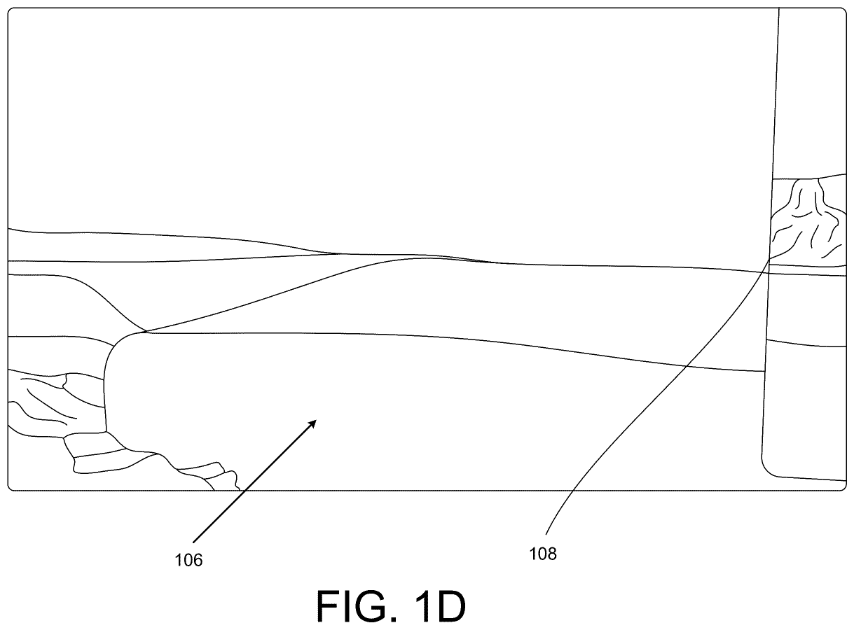

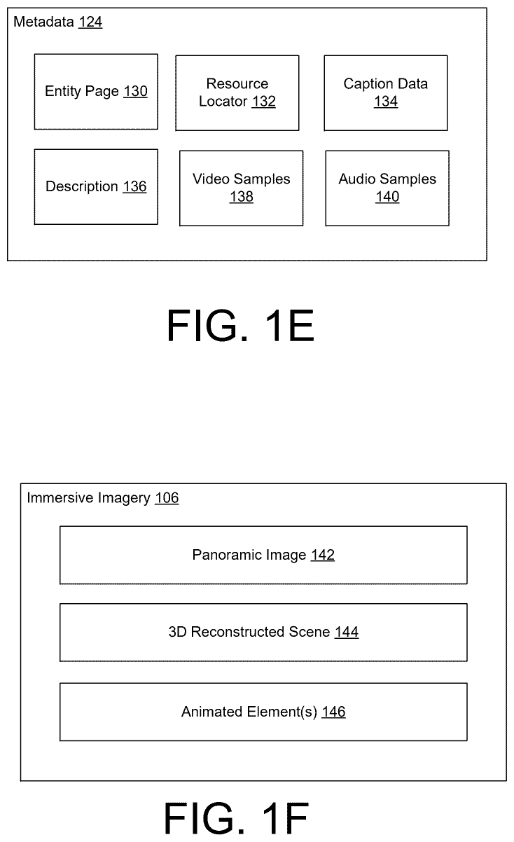

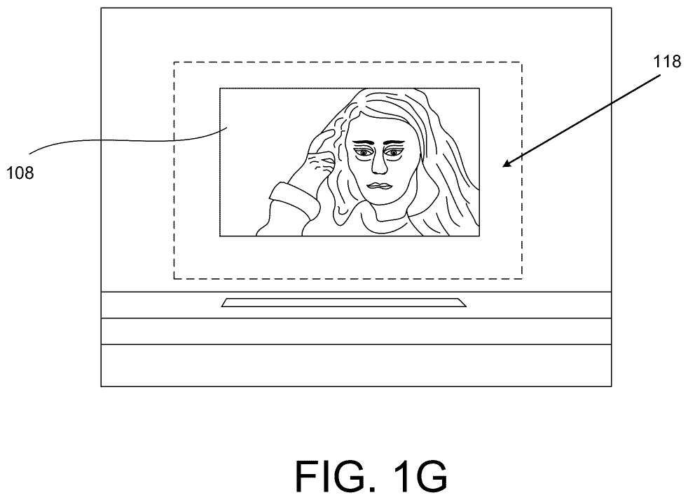

FIGS. 1A to 1G illustrates a system 100 that generates immersive imagery 106 based on metadata 124 and/or a user prompt 126 for display in an immersive environment on an extended reality device 102. The system 100 provides one or more technical benefits of generating immersive imagery 106 (e.g., a panoramic image 142 (e.g., a 360-degree panoramic image) and/or a 360-degree reconstructed scene 144) by reducing the amount of computing resources, reducing the time required for image generation, and/or reducing the number of distortions or artifacts in the immersive imagery 106.

The system 100 includes an immersive imagery engine 120 configured to generate immersive imagery 106 for display on an extended reality (XR) device 102. In some examples, the immersive imagery engine 120 executes on a server computer. In some examples, the immersive imagery engine 120 executes on an operating system 114 of the XR device 102. In some examples, a first portion of the immersive imagery engine 120 is stored on a server computer, and a second portion of the immersive imagery engine 120 is stored on the XR device 102. For example, one or more operations of the immersive imagery engine 120 may be performed by the server computer, and one or more operations of the immersive imagery engine 120 may be performed by the XR device 102.

As shown in FIG. 1A, the immersive imagery engine 120 generates immersive imagery 106 themed to a media item 110, and the XR device 102 may receive and display the immersive imagery 106 as background for a display panel 108 (e.g., a video player window) that displays the two-dimensional (2D) content of the media item 110. The display panel 108 can display a video or an image. In some examples, the display panel 108 displays 2D content.

In some examples, immersive imagery 106 refers to a digital visual environment that is rendered to spatially surround a user's field of view within the XR device 102, where the digital visual environment serves as a background for a foreground display panel 108 and is thematically related to content displayed on the display panel 108. In some examples, the immersive imagery 106 refers to a computer-generated graphical representation of a scene, having a field of view substantially wider than a foreground display panel 108, that is mapped to an interior surface of a virtual shape encompassing a user's viewpoint in an extended reality environment, such that movement of the user's viewpoint results in a corresponding shift in the visible portion of the graphical representation. In some examples, particularly in the context of cross-application transitions, immersive imagery 106 of the first application refers to a computer-generated visual scene that is generated by or on behalf of a first application based on metadata 124 associated with a media item 110 and is displayed on the XR device 102 as a persistent rendering context, where the persistent rendering context is configured to be inherited by a second application for displaying the media item 110 on a display panel 108 positioned within the visual scene.

In some examples, the immersive imagery 106 includes a panoramic image 142 with a wide field of view (e.g., a 360-degree field of view). In some examples, the immersive imagery 106 includes a 360-degree skybox image. A 360-degree skybox image may be a panoramic image 142 that surrounds the user's field of view, creating an immersive virtual environment. As the user manipulates the XR device 102 (e.g., rotating and/or titling the user's head) (e.g., moving from FIG. 1C to 1D), the panoramic image 142 shifts accordingly, thereby giving the user the sensation of being within the scene represented by the immersive imagery 106.

The XR device 102 may render a user interface of an application 112. In some examples, the application 112 is a client application of a media platform 152 that identifies media items 110 available for viewing/streaming. In some examples, the application 112 includes a streaming application. In some examples, the application 112 includes a video-sharing application. In some examples, the application 112 is a photo or image application. In some examples, the application 112 includes a media aggregator application that aggregates media items across multiple streaming platforms in a unified user interface. However, the application 112 may be any type of application such as a map application, a search (e.g., browser) application, or other types of client applications executable by the operating system 114. In some examples, the application 112 is a sub-component of the operating system 114. In some examples, the user interface is a home screen or home skybox of the XR device 102.

The media item 110 may be video such as user-generated content or a program such as a movie, a television show, or a live broadcast. In some examples, the media item 110 is an image. In some examples, the application 112 may provide a selectable control that enables the user to select an immersive mode for viewing the media item 110. In some examples, in response to selection of the immersive mode, the XR device 102 may display the immersive imagery 106 as background for a display panel 108. The display panel 108 displays the 2D content of the selected media item 110. For example, the user can watch the 2D content in the display panel 108 while being immersed in the immersive imagery 106.

In some examples, the display panel 108 includes a curved display or screen. The display panel 108 may be referred to as a virtual display panel or a virtual interface that can display an image or a video. The display panel 108 is positioned at a particular location of the scene. In some examples, the display panel 108 is world locked (e.g., the object is anchored to a specific point in the immersive environment, despite movement of the XR device 102). In some examples, the display panel 108 is not world locked. The display panel 108 includes a curvature radius (a radius value) that may be set by the application 112 (or the media platform 152), and, in some examples, may be adjustable by a user via a settings interface. In some examples, the immersive imagery 106 is based on the theme of the content the user is viewing via the display panel 108 (e.g. if the user has selected Star Wars for viewing, their extended reality environment may change to a planetary skybox image). As shown in FIG. 1B, the user has selected a first media item, which causes the XR device 102 to display the immersive imagery 106 themed to the first media item. As shown in FIG. 1C, the user has selected another media item (e.g., a second media item), which causes the XR device 102 to display different immersive imagery 106 themed to the second media item.

The immersive imagery 106 include one or more animated elements 146 generated by the immersive imagery engine 120. For example, the scene depicted by the immersive imagery 106 may include one or more animated elements 146 that move or change over time. In other words, animated elements 146 in the immersive imagery 106 may refer to dynamic elements in the panoramic image 142 that move or change over time (e.g., leaves moving on trees, birds flying overhead, movement of waves in the ocean, or stars can be animated to simulate their movement across the night sky, creating a sense of time and realism, clouds can be animated to drift across the sky, changing shape and density, rain, snow, fog, and other weather effects can be simulated to create immersive atmospheric conditions, intensity and direction of light can change over time, creating dynamic lighting effects, certain objects within the immersive imagery can be interactive, allowing users to manipulate them or trigger specific events such as another immersive imagery, including 3D scene content). In some examples, the immersive imagery 106 includes one or more virtual objects (e.g., interactive virtual objects) that the user can interact with.

In some examples, the XR device 102 includes a dynamic hue engine 116 configured to render a visual effect 118 (e.g., at least partially around or fully around) the display panel 108. In some examples, the visual effect 118 includes a dynamic display of colored flares or haloes that change color in real-time to match the dominant hues in the media item 110. In some examples, the visual effect 118 is referred to as a dynamic hue screen extension. In some examples, the visual effect 118 includes adaptive virtual color flares surrounding the display panel 108 in which the media item 110 is being viewed (“extended screen”). The virtual color flares may change based on the colors in the content (e.g., a gardening “how to” video may cause the dynamic hue engine 116 to display adaptive green flares surrounding the display panel 108). The dynamic hue engine 116 analyzes the color content of the video or image being played and then generates the visual effect 118 around the display panel 108. The visual effect 118 may include the display of colored flares or halos that change color in real-time to match the dominant hues in the playback content.

A visual effect 118 may include a dynamic display rendered at least partially around a display panel 108, where colors of the dynamic display change in real-time to correspond to dominant hues in content displayed on the display panel 108. A visual effect 118 may include a dynamic hue screen extension generated by a dynamic hue engine 116, the dynamic hue screen extension rendered proximate to a display panel 108 and configured to adapt based on color content being played on the display panel 108. A visual effect 118 may be generated by analyzing color content of a media item 110 being displayed, where the visual effect 118 includes an adaptive display rendered in proximity to a display panel 108 showing the media item 110, where the adaptive display is modified in real-time to correspond to the analyzed color content.

In some examples, instead of displaying the immersive imagery 106 on a display 104 of the XR device 102, the XR device 102 may enable the selection of an augmented reality (AR) mode, which passes through the user's surroundings. For example, in the AR mode, as shown in FIG. 1G, the XR device 102 may display pass-through video of the user's surroundings in the XR environment, and the display panel 108 may be positioned in the user's space in the extended reality environment. In some examples, the dynamic hue engine 116 may adjust the hue of the user's passthrough surroundings to correspond to (e.g., match) the color themes of the content being displayed on the display panel 108. For example, if a user is watching a movie with a predominantly blue color scheme, the dynamic hue engine 116 may cause the real-world environment to appear bluer. In some examples, the dynamic hue engine 116 may analyze the video content being played to determine its dominant colors and overall color palette and perform color filtering on the device's display by filtering the light emitted by the display's pixels. The XR device 102 includes a camera system configured to capture the user's surroundings. In some examples, the dynamic hue engine 116 may use the color information from the video content to adjust the color of the images captured by the camera system.

In some examples, the XR device 102 renders an interface (e.g., a prompt interface) to receive a user prompt 26 (e.g., verbal or text) (e.g., a natural language query) to adjust the immersive imagery 106 or to create a new (e.g., user-specific or custom) immersive imagery 106, which may include changing a portion or an aspect of the immersive imagery 106, generating new immersive imagery 106, and/or animating one or more elements in the immersive imagery 106 and/or adding one or more virtual objects or interactive virtual objects. A virtual object may be interactive when configured to enable a user to select, manipulate, or move the object. A user may submit a user prompt 126 (e.g., via voice or text) (e.g., animate the leaves, enlarge the stars, make brighter). In response to the user prompt 126, the immersive imagery engine 120 may re-generate immersive imagery 106 using the user prompt 126 and the previous panoramic images. In other words, the immersive imagery engine 120 may enable the generation of custom immersive imagery 106. In some examples, the custom immersive imagery 106 may be saved by storing the custom immersive imagery 106 in data storage, e.g., in association with a user account. In some examples, the user may share the immersive imagery 106 with other users of XR devices 102.

As shown in FIG. 1A, the immersive imagery engine 120 may include one or more machine-learning (ML) models 122 (e.g., generative models such as text-to-text generative models, text-to-image generative models, image-to-image generative models and/or multi-modality generative models that can receive text, audio, and/or image in a prompt as an input, and generate text, audio, and/or an image as an output). In some examples, the immersive imagery engine 120 may generate a panoramic image 142 (e.g., a wide image such as a 360-degree image) from a text prompt or a prompt with text, image, and/or video. In some examples, the immersive imagery engine may include a 2D-to-360 image pipeline. The 2D-to-360 degree image pipeline may include a plurality of layers such as prompt engineering, base image generation, field of view extension, upsampling, and/or hue extension.

In some examples, the immersive imagery engine 120 may generate immersive imagery 106 based on metadata 124 associated with the media item 110. In some examples, as shown in FIG. 1E, the metadata 124 may include textual data about the media item 110 such as one or more portions of information of an entity page 130 provided by the media platform 152, a resource locator 132 associated with the media item 110, caption data 134 from the media item 110, and/or a description 136 of the media item 110. In some examples, the metadata 124 includes one or more video samples 138 (or one or more image samples) and/or audio samples 140 from the media item 110. In some examples, the immersive imagery engine 120 may generate an immersive imagery 106 based on the user prompt 126 received via a prompt interface.

For example, the immersive imagery engine 120 may perform prompt engineering by first analyzing the metadata 124 to extract semantic entities such as primary settings (e.g., “a desert planet,” “a futuristic city”), dominant moods (e.g., “dark and mysterious,” “bright and adventurous”), and key objects or styles (e.g., “19th-century architecture,” “glowing neon lights”). The immersive imagery engine 120 may then synthesize these extracted elements into a structured prompt using a predefined template. For instance, a prompt might be constructed as: “[Style], [Setting Description], [Mood], [Key Objects].” This structured prompt is then provided to a generative model (e.g., a ML model 122) to produce the base image, ensuring the output aligns thematically with the media item 110.

In some examples, in addition to (or separately from) generating the immersive imagery 106 based on the metadata 124, the immersive imagery engine 120 may also generate immersive audio data (e.g., sound) that is themed to the media item 110. In some examples, the immersive imagery engine 120 analyzes the metadata 124, and, in some examples, one or more audio samples 140 extracted from the media item 110 to derive acoustic attributes that characterize the media item's auditory style, such as predominant instrument types, ambient background tones, spectral energy distributions, or rhythmic structures. Using these extracted attributes, the immersive imagery engine 120 may generate immersive audio that is perceptually aligned with the visual characteristics of the immersive imagery 106. For instance, the immersive imagery engine 120 may augment the immersive imagery 106 with spatialized ambient audio cues that reflect thematic elements of the media item 110, e.g., such as low-frequency atmospheric tones for suspenseful content, bright harmonic layers for energetic content, or spatial reverberation patterns that simulate the architectural environment depicted by the immersive imagery 106.

In some examples, the immersive imagery engine 120 may generate the immersive audio data in response to receiving the user prompt 126. The user prompt 126 may specify one or more user preferences for mood, intensity, or audio style, and the immersive imagery engine 120 may adapt the immersive audio data to reflect the selected preferences while maintaining thematic consistency with the metadata 124. In some examples, the immersive imagery engine 120 may combine both metadata-driven cues and user-prompt-driven modifications, generating a hybrid audio environment that dynamically aligns with both the underlying narrative elements of the media item 110 and real-time user intent. By generating the themed audio environment in conjunction with the immersive imagery 106, the system enhances perceptual immersion and provides a multisensory experience that reinforces the contextual relevance of the media item 110 within the extended reality environment.

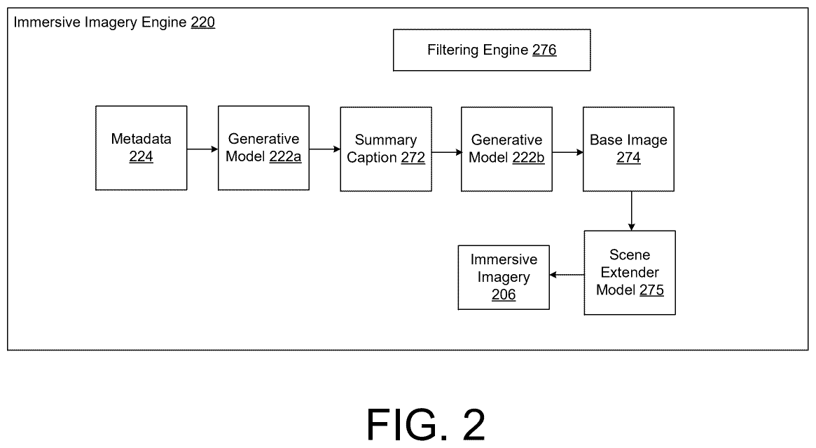

FIG. 2 illustrates an example of an immersive imagery engine 220 according to an aspect. The immersive imagery engine 220 may be an example of any of the immersive imagery engines discussed herein and may include any of the details discussed with reference to the other figures. In some examples, the immersive imagery engine 220 may include (or communicate with) a generative model 222a (e.g., a language model or a large language model). The immersive imagery engine 220 may generate and transmit a prompt that includes the metadata 224 (e.g., the textual data about the media item) (or a user prompt), and the generative model 222a receives the prompt as an input and generates a summary caption 272 as an output. The summary caption 272 may be a short phrase describing the theme of an image to be created.

The immersive imagery engine 220 may communicate with a generative model 222b (e.g., the same generative model or a different generative model with respect to generative model 222a) to generate a base image 274 (e.g., a 2D image) using the summary caption 272 as an input. In some examples, the immersive imagery engine 220 includes a scene extender model 275 configured to receive the base image 274 and generate the immersive imagery 206 from the base image 274. The immersive imagery 206 may be a larger panoramic image (e.g., a 360 degree panoramic image). The scene extender model 275 may include one or more ML models that extend the field of view of the base image 274 to a larger image.

In some examples, the immersive imagery engine 220 includes a filtering engine 276 that applies one or more policy controls to the base image 274 and the immersive imagery 206. For example, the filtering engine 276 may detect/determine that the base image 274 and/or the immersive imagery 206 do not include profanities, images of people or children, and/or other policy and/or security checks.

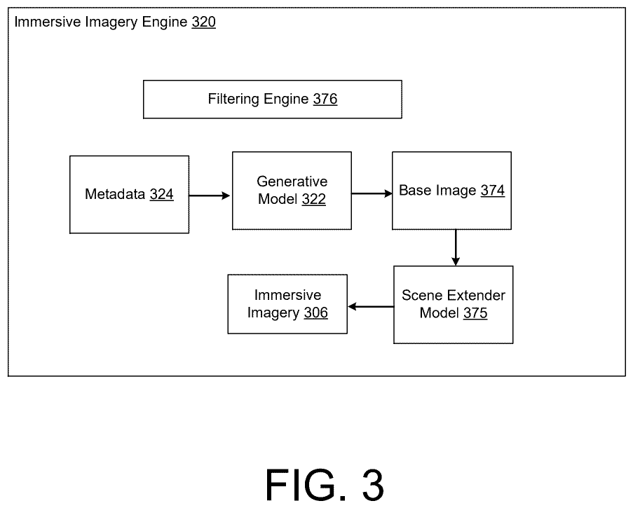

FIG. 3 illustrates an example of an immersive imagery engine 320 according to an aspect. The immersive imagery engine 320 may be an example of any of the immersive imagery engines discussed herein and may include any of the details discussed with reference to the other figures. In some examples, instead of generating a summary caption, the immersive imagery engine 320 provides a prompt with the metadata 324 about the media item (or a user prompt) to a generative model 322, and the generative model 322 generates a base image 374 using the metadata 324 or the user prompt. Similar to the example of FIG. 2, the immersive imagery engine 320 includes a scene extender model 375 configured to receive the base image 374 and generate the immersive imagery 306 from the base image 374. The immersive imagery 306 may be a larger panoramic image, e.g., a 360 degree panoramic image. The scene extender model 375 may include one or more ML models that extend the field of view of the base image 374 to a larger image. In some examples, the immersive imagery engine 320 includes a filtering engine 376 that applies one or more policy controls to the base image 374 and the immersive imagery 306. For example, the filtering engine 376 may detect/determine that the base image 374 and/or the immersive imagery 306 do not include profanities, images of people or children, and/or other policy and/or security checks. If the filtering engine 376 determines that the base image 374 and/or the immersive imagery 306 violates one or more policy controls, the filtering engine 376 may cause the immersive imagery engine 320 to re-generate the base image 374 and/or the immersive imagery 306.

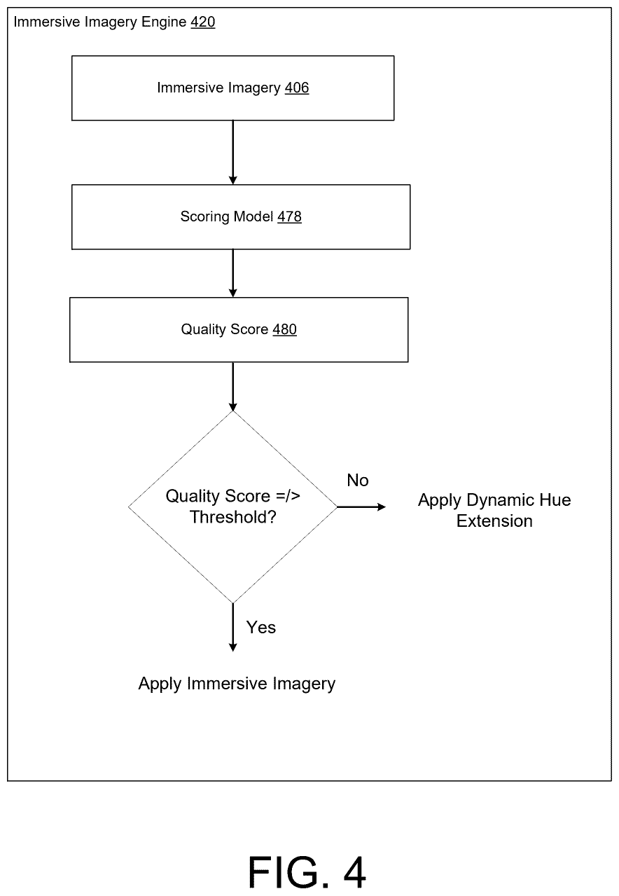

FIG. 4 illustrates an example of an immersive imagery engine 420 according to another aspect. The immersive imagery engine 420 may be an example of any of the immersive imagery engines discussed herein and may include any of the details discussed with reference to the other figures. In some examples, the immersive imagery engine 420 includes a scoring model 478 configured to generate a quality score 480 (e.g., a quality metric) for the immersive imagery 406. The scoring model 478 is configured to generate the quality score 480 (e.g., level of quality of the panoramic image) based on prompt alignment, image fidelity (e.g., closeness to the ground truth 2D image), and/or seam alignment. If the quality score 480 does not satisfy (e.g., is equal or greater) than a threshold level, the immersive imagery engine 420 may provide the immersive imagery 406 for display on the extended reality device. In response to the quality score 480 being less than the threshold level, the immersive imagery engine 420 may cause the extended reality device to activate a dynamic hue engine to provide a visual hue effect on video-pass through.

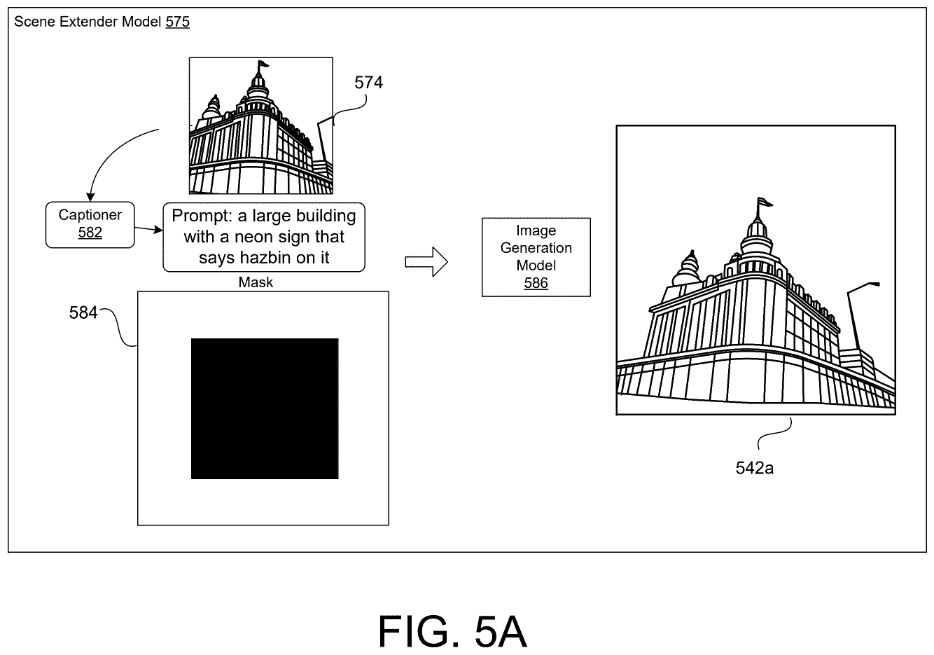

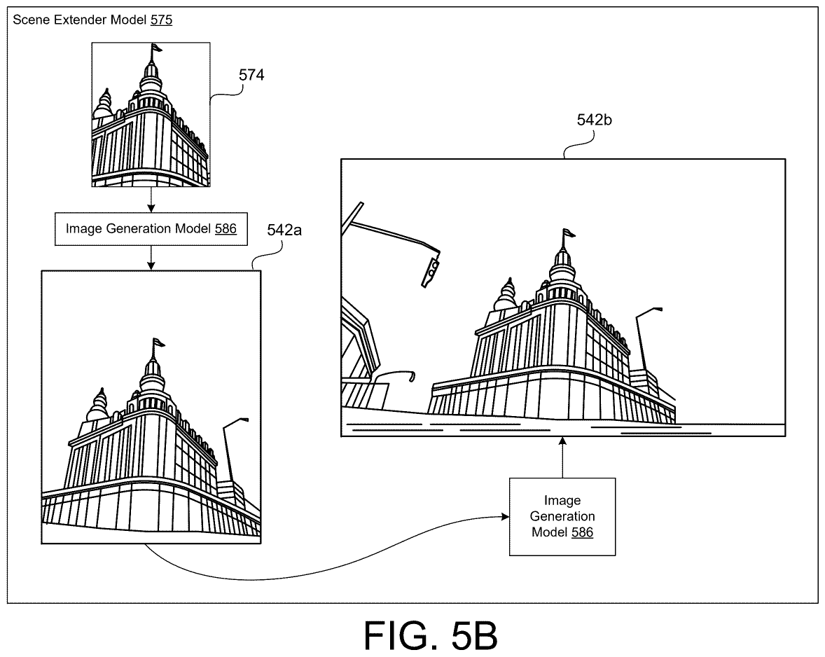

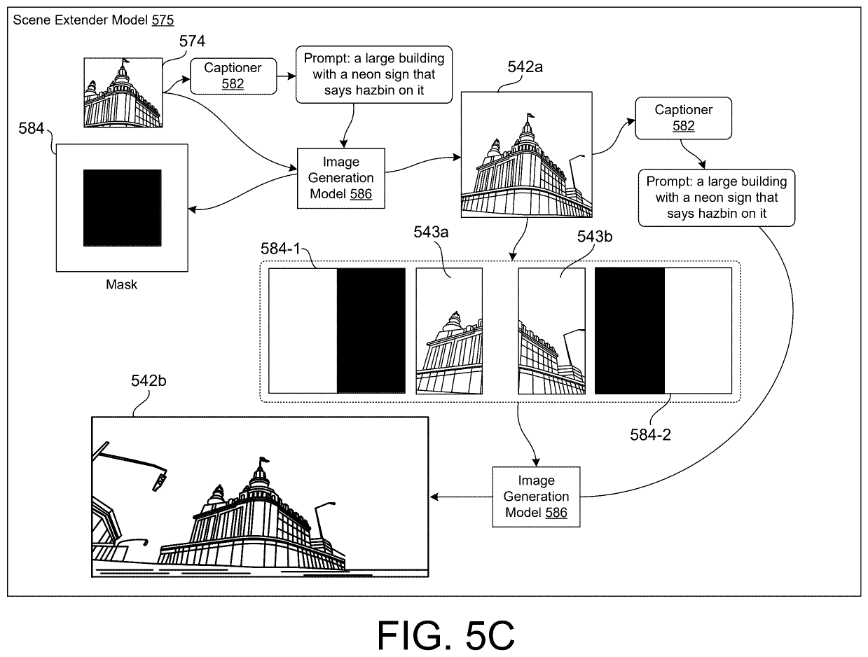

FIGS. 5A to 5C illustrates an example of a scene extender model 575. The scene extender model 575 may be an example of the scene extender model 275 of FIG. 2 and may include any of the details with respect to FIG. 2. The scene extender model 575 may include a captioner 582 and an image generation model 586. The captioner 582 may be a generative model configured to generate a caption (also referred to as a prompt) for an input image. In some examples, the image generation model 586 is an out-painting ML model configured to extend a field of view of an input image (e.g., a base image 574).

The captioner 582 receives the base image 574 and generates a caption (e.g., a short summary) about the base image 574. The scene extender model 575 generates a mask 584. The scene extender model 575 may generate the mask 584 by padding the base image 574 equally on left, right, top and bottom. In some examples, to reduce artifacts, the scene extender model 575 creates the mask 584 by applying a morphological operation, dilation, by convolving the initial mask with a square kernel. The image generation model 586 receives the base image 574, the caption, and the mask 584, and generates a panoramic image 542a. Then, the scene extender model 575 obtains the panoramic image 542a, partitions (e.g., splits) the panoramic image 542a (e.g., in half), thereby generating a left slice 543a (e.g., a first portion) and a right slice 543b (e.g., a second portion). Then, the scene extender model 575 obtains the left slices 543a, pads the panoramic image 542a on the left slices 543a (e.g., add extra pixels or space) to derive a square padded image. Then, the scene extender model 575 creates the respective mask (584-1, 584-2) using the same or similar dilation operation. Given the padded left slice image as input base image, the scene extender model 575 performs a similar process as described above. The scene extender model 575 repeats the same process for the right slice 543b of the panoramic image 542a. The scene extender model 575 stitches the left and right out-painting to get the final landscape image (e.g., the panoramic image 542b).

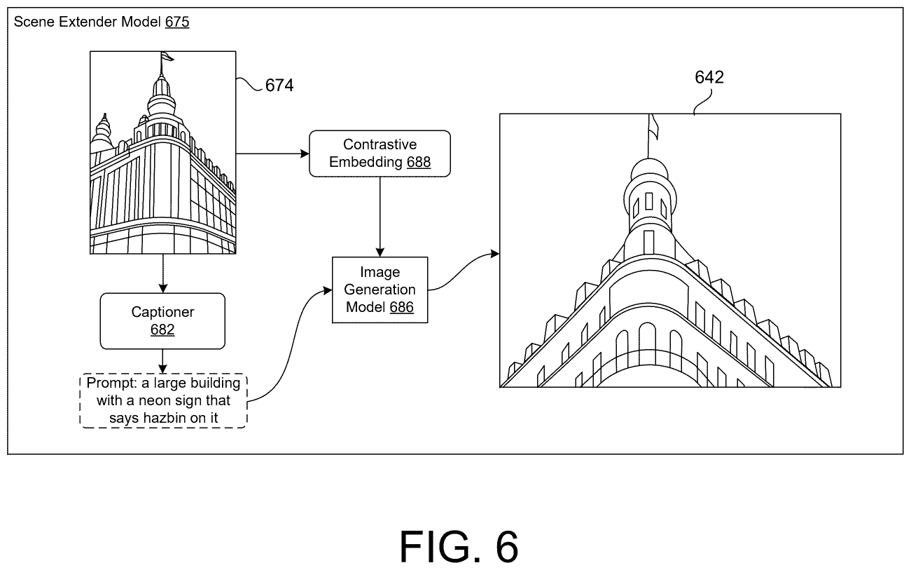

FIG. 6 illustrates a scene extender model 675 according to another aspect. The scene extender model 675 may include a captioner 682, an image generation model 686, and may generate a contrastive embedding 688 for the image generation model 686. The scene extender model 675 may generate a contrastive embedding 688 (also referred to as an embedding or an embedding vector) using a reference image 674 as an input. The captioner 682 receives a reference image 674 (e.g., a base image or an immediate panoramic image) and generates a caption (e.g., a short description or phrase about the image). The scene extender model 675 conditions the image generation on the contrastive embedding 688 (e.g. an embedding vector). The scene extender model 675 feeds the embedding vector (e.g., the contrastive embedding 688), the caption (e.g., prompt) generated by the captioner 682, and scale parameter to generate landscape images (e.g., panoramic image 642) of a certain size. The scene extender model 675 can control the similarity of generated images with respect to the reference image 674 using the scale parameter, which controls conditioning strength. The higher the scale, the stronger the influence from the reference image 674.

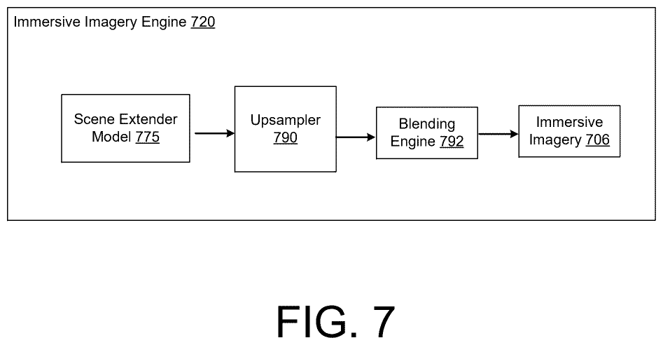

FIG. 7 illustrates an immersive imagery engine 720 according to another aspect. The immersive imagery engine 720 may be an example of the immersive imagery engine 120 of FIG. 1A, the immersive imagery engine 220 of FIG. 2, the immersive imagery engine 320 of FIG. 3, and/or the immersive imagery engine 420 of FIG. 4 and may include any of the details with respect to the other figures. The immersive imagery engine 720 includes a scene extender model 775 configured to generate a panoramic image from a base image. The immersive imagery engine 720 includes an upsampler 790 configured to upsample the panoramic image from the scene extended model 775 to a higher resolution. In some examples, the upsampler 790 uses bilinear upsampling. In some examples, the upsampler 790 uses diffusion model-based upsampling. In some examples, the immersive imagery engine 720 includes a blending engine 792 configured to blend aspects of the output image (e.g., blend edges of landscape using hue extension, and blend hue extension to back for full 360 panorama) to generate the final immersive imagery (immersive imagery 706).

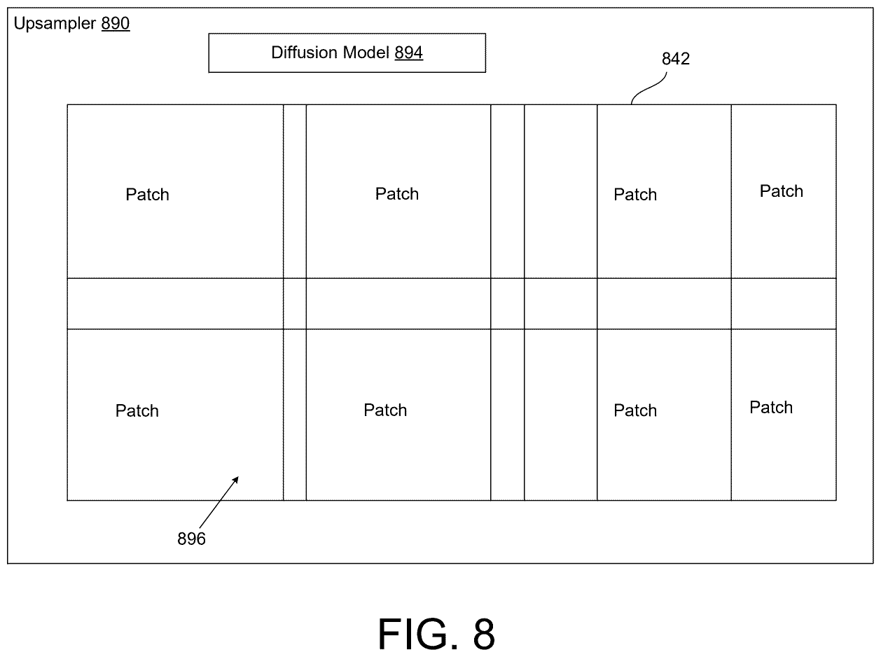

FIG. 8 illustrates an example of an upsampler 890 according to an aspect. The upsampler 890 may be an example of the upsampler 790 of FIG. 7 and may include any of the details with respect to the other figures. In some examples, the upsampler 890 includes a diffusion model 894. In order to perform diffusion-based upsampling, the upsampler 890 divides the input image 842 into X overlapping patches 896. The patch size may correspond to (e.g., match) the size that the diffusion model 894 accepts as input. The upsampler 890 upsamples the patches 896 using the diffusion model 894. This can be done in parallel, and the upsampling factor may be fixed. In some examples, the upsampler 890 can blend together the upsampled patches by taking the overlapping area into account and blending them together.

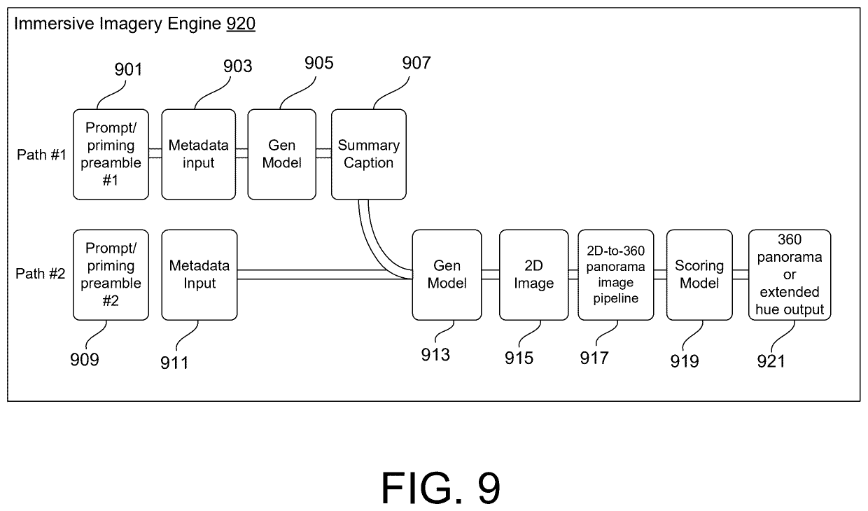

FIG. 9 illustrates an example of an immersive imagery engine 920 for generating immersive imagery. The immersive imagery engine 920 may be an example of the immersive imagery engine 120 of FIG. 1A, the immersive imagery engine 220 of FIG. 2, the immersive imagery engine 320 of FIG. 3, the immersive imagery engine 420 of FIG. 4, and/or the immersive imagery engine 720 of FIG. 7 and may include any of the details with respect to the other figures.

As shown in FIG. 9, the immersive imagery engine 920 provides two alternative processing paths (e.g., path #1 and path #2) for generating a 360-degree panorama or an extended-hue output based on metadata associated with a media item. Each path represents a different model-conditioning strategy depending on available metadata and system latency constraints.

Path #1 begins at operation 901, in which a first prompt-priming preamble is generated based on textual metadata describing the media item. This preamble may include contextual framing text used to guide a large-language model toward generating a concise thematic summary of the media item. Operation 903 includes providing metadata input (e.g., title, description, captions, or structured entity-page metadata) to a generative model 905. Operation 907 includes generating, by the generative model, a summary caption based on the metadata input. Operation 913 including providing the summary caption as an input to the generative model. Operation 915 includes generating, by the generative model, a 2D image using the summary caption. Operation 917 includes processes the 2D image through the 2D-to-360 panorama image pipeline to generate a panoramic image, which may include outpainting, field-of-view extension, hue extension, and/or image upsampling. Operation 919 includes evaluating the panoramic image using a scoring model that assesses prompt alignment, image fidelity, and/or filtering-layer restrictions. If the candidate panoramic image does not satisfy the scoring threshold, the system applies dynamic hue extension at operation 921 to generate a fallback extended-hue environment. If the candidate panoramic image satisfies the scoring threshold, the system applies the panoramic image at operation 921.

Path #2 may be a lower-latency alternative that bypasses the summary-caption stage. Path #2 begins at operation 909, which generates a second prompt-priming preamble, potentially optimized for direct conditioning of the generative model without intermediate text summarization. Operation 911 includes providing the metadata input to a generative model. Operation 913 includes generating, by the generative model, a 2D image using the metadata input. This flow allows the metadata to act as direct conditioning input to the generative model, reducing processing latency and avoiding reliance on a caption-generation stage. The output of operation 913 then proceeds through operations 915, 917, 919, and 921 in the same manner described for path #1, producing either a 360-degree panorama or an extended-hue environment depending on the scoring outcome.

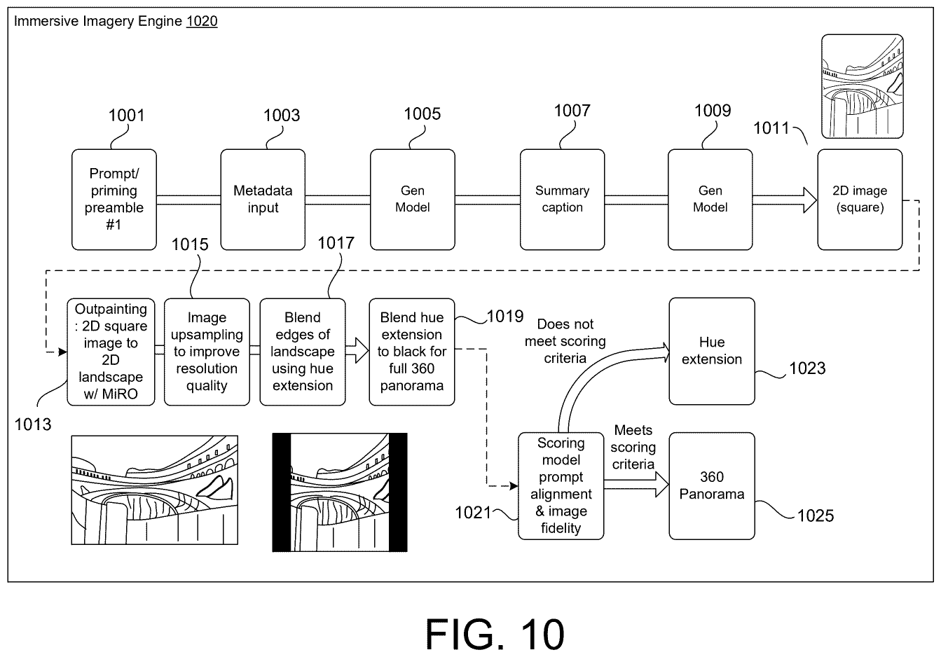

FIG. 10 illustrates an example of an immersive imagery engine 1020 for generating immersive imagery. The immersive imagery engine 1020 may be an example of the immersive imagery engine 120 of FIG. 1A, the immersive imagery engine 220 of FIG. 2, the immersive imagery engine 320 of FIG. 3, the immersive imagery engine 420 of FIG. 4, the immersive imagery engine 720 of FIG. 7, and/or the immersive imagery engine 920 of FIG. 9 and may include any of the details with respect to those figures.

In some examples, the immersive imagery engine 1020 executes a pipeline that begins at operation 1001, in which a first prompt-priming preamble is generated. This first preamble may include system-level framing text designed to steer a generative model toward producing a high-level thematic summary that reflects the semantics of the media item. Operation 1003 includes providing metadata input (e.g. textual metadata, entity-page text, description fields, or extracted caption data) to the generative model in combination with the first prompt-priming preamble. Operation 1005 includes generating, by the generative model, a summary caption that distills the theme or narrative content of the media item into a condensed sentence suitable for guiding subsequent image generation.

Operation 1007 includes providing the summary caption as an input to the generative model. Operation 1009 includes generating, by the generative model, a 2D image based on the summary caption. Operation 1011 includes providing the 2D image to an outpainting engine. Operation 1013 includes expanding, by an outpainting engine, the base 2D image into a wide-aspect 2D landscape representation that increases the horizontal field of view while preserving key semantic elements of the generated image. Operation 1015 includes performing image upsampling on the outpainted image in order to improve spatial resolution and detail quality, using either classical upsampling or a patch-based diffusion upsampler configured to enhance visual fidelity.

Operation 1017 includes applying hue-extension blending to the lateral edges of the upsampled landscape image, thereby softening visual seams and expanding the apparent field of view into a partially panoramic form. Operation 1019 includes applying additional hue-blending to extend the color gradients of the image to black, generating a continuous 360-degree panoramic representation suitable for display in an extended-reality environment. Operation 1021 includes evaluating the generated 360-degree panoramic image using a scoring model that assesses prompt alignment, image fidelity, artifact presence, and/or suitability under responsible-AI filtering constraints. Operation 1023 includes determining whether the scoring model indicates that the generated immersive imagery should be used; if the imagery does not satisfy scoring requirements, the immersive imagery engine 1020 generates a fallback extended-hue environment instead of a full panorama. If the imagery satisfies the scoring threshold, operation 1025 includes applying the generated 360-degree panorama as the immersive imagery for the extended-reality experience.

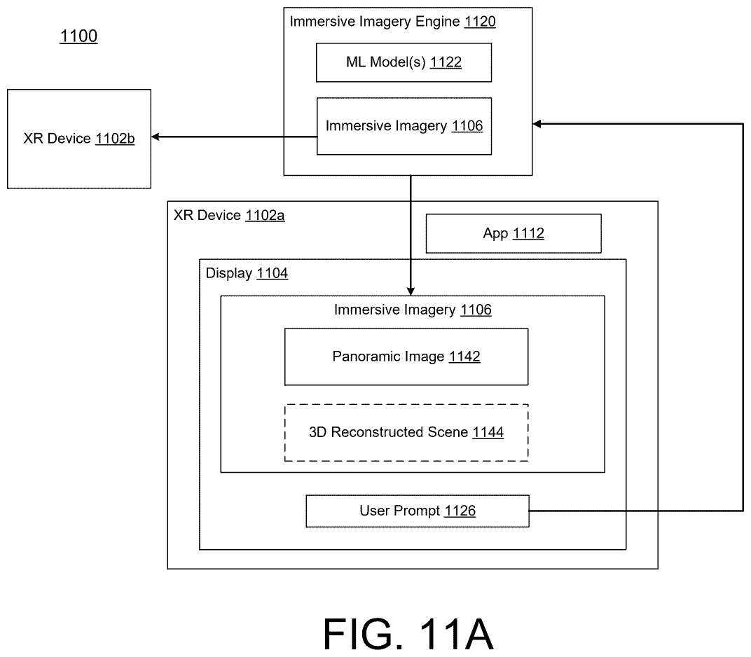

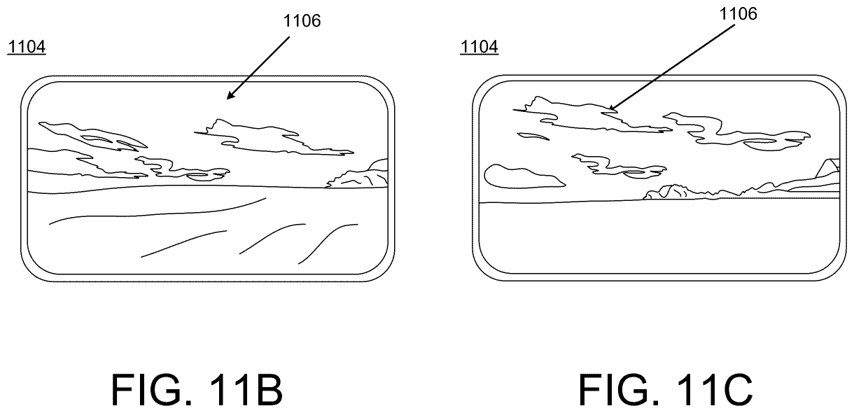

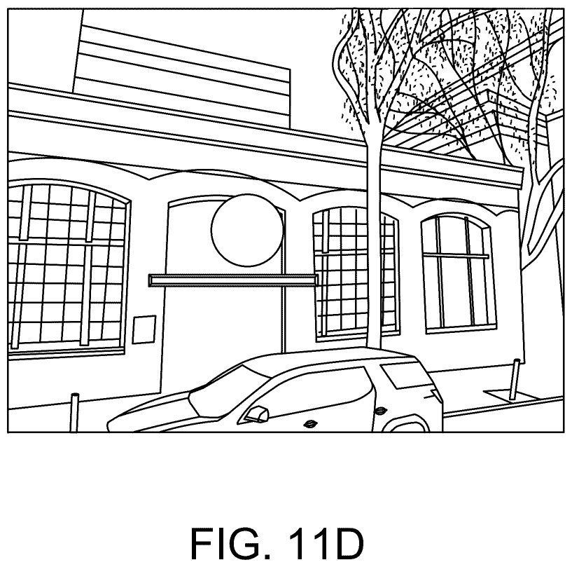

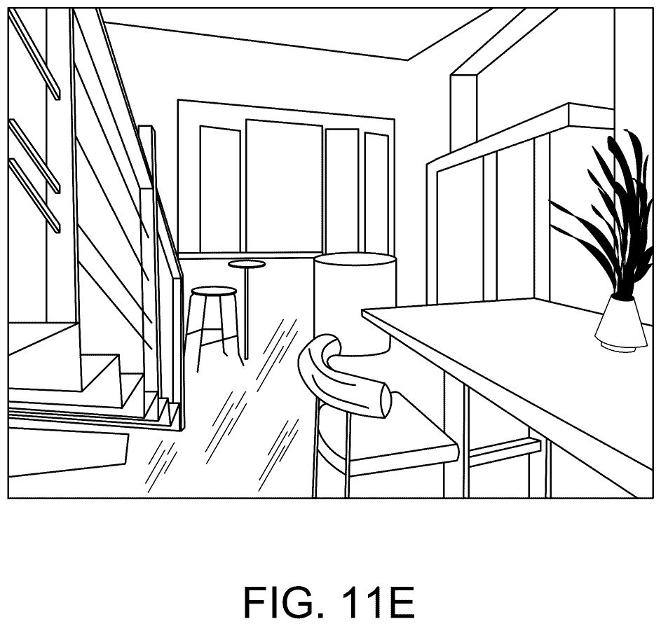

FIGS. 11A to 11C illustrate a system 1100 for generating immersive imagery 1106 for an XR device 1102a. The system 1100 may be an example of the systems and components of the previous figures and may include any of the details discussed with reference to the previous figures. In some examples, the immersive imagery 1106 includes a panoramic image 1142. In some examples, the immersive imagery 1106 includes a 3D reconstructed scene 1144. FIG. 11B illustrates a view of the immersive imagery 1106. Then, the user may manipulate the XR device 1102a (e.g., rotate/tilt the user's head), which causes the XR device 1102a to display other portions of the immersive imagery 1106, as shown in FIG. 11C.

In some examples, instead of the immersive imagery 1106 being themed to a particular media item (and then adjust the immersive imagery 1106 using a user prompt), the immersive imagery engine 1120 may generate immersive imagery 1106 for an interface (e.g., primary interface) of the XR device 1102a based on a user prompt 1126. In some examples, the interface is an interface of the operating system of the XR device 1102a. In some examples, the interface includes a 360-degree home skybox. A 360-degree home skybox is a virtual environment in which the user can access applications, widgets, and/or other functions. For example, a user may submit a user prompt 1126 (e.g., via voice or text), and, in response to the user prompt 1126, the immersive imagery engine 1120 may generate immersive imagery 1106 based on the user prompt 1126. For example, a user may enter the 360-degree home skybox, and, using natural language (e.g., voice or text prompt), the user asks to be taken to a tulip field in Amsterdam on a bright spring day. The user's 360 degree home skybox is then surrounded by vibrant tulips of every color against the backdrop of a bright blue sky. Later in the day, the user may submit a natural language prompt to change her skybox scene to a sand garden with natural earth tones. The user may submit additional user prompts 1126 to adjust the immersive imagery 1106, add animated elements, and/or virtual objects.

In some examples, the immersive imagery 1106 includes a 3D reconstructed scene 1144 representing a virtual-world scene or real-world scene. In some examples, the 3D reconstructed scene 1144 may be generated based on video and/or images of a real-world scene. In some examples, the camera system on the XR device 1102a may capture images and/or a video of the user's physical space, and the immersive imagery engine 1120 may generate a 3D reconstructed scene 1144 using the captured sensor data (e.g., the images and/or video), which can be displayed as the user's skybox. For example, the XR device 1102a may display the 3D reconstructed scene 1144 in an interface (e.g., 360 home skybox or a media viewing interface with a video media player). The use of 3D reconstructed scene 1144 may allow a user to explore the scene from any angle, zoom in on specific details, and, in some examples, interact with one or more virtual objects within the scene. In some examples, the XR device 1102a may provide an interface for receiving one or more user prompts 1126 (e.g., natural language queries) to be used in prompts for adjusting the 3D reconstructed scene 1144, including the changing of certain aspects of the scene and/or the addition or deletion of other objects. In some examples, the system 1100 may enable the storage of 3D reconstructed scenes 1144, as well as the ability for the user to share their 3D reconstructed scenes 1144 with other users, e.g., XR device 1102b.

In some examples, the immersive imagery engine 1120 is associated with a database that stores a number of pre-generated 3D reconstructed scenes 1144 (or panoramic images 1142) or user-saved immersive imageries of various scenes, and the immersive imagery engine 1120 may search the database to select one or more 3D reconstructed scenes 1144 (or panoramic images 1142) that is responsive to a user's search. In response to selection of a particular 3D reconstructed scene 1144, the extended reality device may provide the 3D reconstructed scene 1144 in the user's skybox for a particular interface such as a media viewing interface, a skybox home interface, or another interface of the operating system or an application executing on the operating system.

In some examples, the immersive imagery engine 1120 generates the 3D reconstructed scene 1144 using one or more ML models 1122. In some examples, generating the 3D reconstructed scene 1144 includes processing sensor data captured by the extended reality device 1102a. As shown in FIGS. 11A-11E, the extended reality device 1102a may include one or more cameras (e.g., RGB cameras, depth sensors, or LiDAR sensors) that capture images and/or video of the user's physical environment for use by the immersive imagery engine 1120. The immersive imagery engine 1120 may perform camera-pose estimation for frames captured by the XR device 1102a using visual-inertial odometry, feature-tracking techniques, simultaneous localization and mapping (SLAM), structure-from-motion, or other approaches to determine the relative position and orientation of the XR device 1102a during capture. The determined camera poses may be used to align the captured frames in a consistent coordinate system for subsequent 3D reconstruction.

In some examples, the immersive imagery engine 1120 generates one or more depth maps for the captured frames. The depth maps may be generated using stereo disparity estimation, multi-view depth prediction, depth values obtained directly from a depth sensor associated with the XR device 1102a, or machine-learning models configured to infer depth from monocular imagery. The immersive imagery engine 1120 may refine the depth maps using temporal smoothing, spatial filtering, confidence weighting, or depth-completion networks configured to infer missing depth values. The refined depth maps may be used by the immersive imagery engine 1120 to generate the 3D reconstructed scene 1144 displayed on the display 1104.

In some examples, the immersive imagery engine 1120 performs volumetric fusion to integrate multiple depth maps into a volumetric representation of the user's environment. For example, the immersive imagery engine 1120 may maintain a truncated signed-distance-function (TSDF) volume, an occupancy grid, a voxel representation, or another volumetric data structure that encodes the geometry of the scene. As new frames are captured by the XR device 1102a, the immersive imagery engine 1120 updates the volumetric representation and applies surface-extraction algorithms (e.g., Marching Cubes, dual contouring, Poisson surface reconstruction, or other mesh-generation techniques) to produce a 3D mesh representing the 3D reconstructed scene 1144. The resulting 3D reconstructed scene 1144 may include real-world surfaces such as floors, walls, ceilings, or objects present in the user's physical space.

In some examples, the immersive imagery engine 1120 applies texture mapping to the 3D reconstructed scene 1144. Texture mapping may include projecting RGB image data captured by the XR device 1102a onto the mesh surfaces, generating a texture atlas, blending textures from multiple camera viewpoints, or using texture-completion models to fill in regions with insufficient camera coverage. In some examples, the immersive imagery engine 1120 evaluates ambient lighting conditions from the captured frames and applies relighting, tone-mapping, white-balance adjustments, or illumination normalization so that the textures of the 3D reconstructed scene 1144 appear visually consistent when displayed on the display 1104.

In some examples, the immersive imagery engine 1120 performs post-processing operations on the 3D reconstructed scene 1144 to optimize the reconstructed geometry for display on the XR device 1102a. Post-processing may include mesh simplification, smoothing, hole filling, normal estimation, removal of low-confidence geometry, or segmentation of reconstructed surfaces. For example, the immersive imagery engine 1120 may classify surfaces of the 3D reconstructed scene 1144 as floor surfaces, wall surfaces, table surfaces, or other detected surfaces, enabling the system 1100 to support interactions or virtual-object placement within the reconstructed environment. In some examples, the XR device 1102a receives a user prompt 1126 (e.g., via voice or text) that requests one or more modifications to the 3D reconstructed scene 1144, such as replacing a texture, enlarging an object, removing an object, or adding one or more virtual objects anchored to surfaces of the 3D reconstructed scene 1144.

In some examples, instead of using the camera system of the XR device 1102a, the immersive imagery engine 1120 may receive video, image sequences, or panoramic captures originating from an application 1112 (e.g., a map application providing street-view or area-view images) as shown in FIGS. 11D and 11E. The immersive imagery engine 1120 may generate the 3D reconstructed scene 1144 using multi-view stereo, neural radiance field reconstruction, or hybrid reconstruction pipelines. The immersive imagery engine 1120 may store the resulting 3D reconstructed scene 1144 in association with the user account and may provide the 3D reconstructed scene 1144 as an immersive environment for a media viewing interface, a skybox-home interface, or another interface executed by the operating system of the XR device 1102a.

In some examples, the 3D reconstructed scene 1144 may represent a virtual environment rather than a reconstruction of a physical environment captured by the XR device 1102a. For example, the immersive imagery engine 1120 may receive a virtual-scene specification that identifies one or more virtual objects, virtual backgrounds, lighting parameters, or scene layouts, and may generate the 3D reconstructed scene 1144 using generative-model pipelines or 3D-asset libraries. The immersive imagery engine 1120 may generate the geometry of the 3D reconstructed scene 1144 using procedural-generation techniques, computer-graphic modeling, machine-learning-based 3D scene synthesis, or text-to-3D models configured to output three-dimensional meshes or neural representations based on a text prompt or metadata.

In some examples, the immersive imagery engine 1120 retrieves one or more 3D models from a database associated with the XR device 1102a or a server system. The database may store virtual objects and virtual scene elements such as terrain meshes, room layouts, architectural models, landscape elements, sky domes, skyboxes, or virtual furniture. The immersive imagery engine 1120 may assemble these virtual objects into the 3D reconstructed scene 1144 according to the metadata of a media item displayed on the display 1104 or according to a user prompt 1126. For example, in response to a user prompt 1126 requesting “a medieval tavern,” the immersive imagery engine 1120 may retrieve virtual tables, chairs, lantern models, and textured wall elements and may arrange them within the 3D reconstructed scene 1144.

In some examples, the immersive imagery engine 1120 may generate the 3D reconstructed scene 1144 using one or more neural rendering techniques that synthesize a virtual environment directly from a text description or metadata. The immersive imagery engine 1120 may generate a neural radiance field, a signed-distance-field representation, or another neural 3D representation of the virtual environment. The immersive imagery engine 1120 may convert the neural representation to a mesh, voxel map, or rendered panoramic output used in the immersive environment of the XR device 1102a. The immersive imagery engine 1120 may also apply lighting models, material shaders, and texture-generation models to provide realistic visual details for objects in the 3D reconstructed scene 1144.

In some examples, the 3D reconstructed scene 1144 includes a hybrid scene in which virtual elements are combined with real-world geometry reconstructed from sensor data captured by the XR device 1102a. For example, the immersive imagery engine 1120 may reconstruct the walls and floor of a room from sensor data and may insert virtual objects into the reconstructed room, such as virtual furniture, lighting fixtures, animated elements, or other interactive objects. The immersive imagery engine 1120 may anchor the virtual objects to surfaces of the 3D reconstructed scene 1144, enabling the XR device 1102 a to maintain consistent placement of these objects as the user changes viewpoint.

In some examples, a user may submit a user prompt 1126 to modify the 3D reconstructed scene 1144 when the 3D reconstructed scene 1144 represents a fully virtual or hybrid environment. For example, a user may request to “add a flowing river on the left side,” “remove the mountains,” “make the room larger,” or “add animated lanterns,” and the immersive imagery engine 1120 may update the 3D reconstructed scene 1144 accordingly. The immersive imagery engine 1120 may regenerate or adjust geometry, textures, lighting, or object placement to reflect the requested change. The updated 3D reconstructed scene 1144 may then be presented on the display 1104 of the XR device 1102a.

In some examples, the application 1112 may identify a virtual location (e.g., a fictional world, a game location, a computer-generated building, or an artist-created 3D model), and the immersive imagery engine 1120 may retrieve a corresponding 3D reconstructed scene 1144 representing that virtual location. The immersive imagery engine 1120 may render the 3D reconstructed scene 1144 as a skybox environment or as a navigable 3D environment in which the user may view a media item, interact with objects, or navigate between virtual areas. For example, the immersive imagery engine 1120 may provide a themed virtual environment that corresponds to the metadata of a movie or television program, enabling the user to watch the program within a fictional scene generated as the 3D reconstructed scene 1144.

In some examples, the 3D reconstructed scene 1144 may include one or more embedded virtual objects that serve as selectable entry points into additional scenes. These embedded virtual objects may be displayed as part of the 3D reconstructed scene 1144 or as part of an area view or street view provided by the application 1112. For example, as shown in FIGS. 11D and 11E, the user may view a street-level representation of a location and may observe a virtual bubble, marker, or icon positioned over a physical structure (e.g., a building). The immersive imagery engine 1120 may associate the marker with a corresponding 3D reconstructed scene 1144 representing the interior of that structure. In response to selection of the marker by the user, the immersive imagery engine 1120 may transition from the area view or street view to display the associated 3D reconstructed scene 1144 on the display 1104 of the XR device 1102a.

In some examples, the 3D reconstructed scene 1144 displayed after the transition may include a navigable interior environment in which the user can rotate or tilt the XR device 1102a to inspect the surrounding geometry. The immersive imagery engine 1120 may generate the interior 3D reconstructed scene 1144 using captured sensor data, multi-view image data, or a virtual-scene generation pipeline, depending on whether the interior environment corresponds to a real-world location or a virtual environment defined by metadata or a user prompt 1126. The immersive imagery engine 1120 may support nested transitions, where a 3D reconstructed scene 1144 contains additional embedded virtual objects that, when selected, cause the XR device 1102a to display another 3D reconstructed scene 1144 associated with the selected object.

In some examples, the scene-within-a-scene transition is not limited to area views or street views. For example, the user may be viewing immersive imagery 1106 or a 3D reconstructed scene 1144 themed to a fictional or virtual setting. The immersive imagery engine 1120 may embed virtual objects within the 3D reconstructed scene 1144, such as a virtual vehicle, architectural element, structure, or animated object. In response to selection of one of these embedded objects, the immersive imagery engine 1120 may render a new 3D reconstructed scene 1144 that corresponds to an interior, alternate perspective, or expanded environment associated with the selected object.

In some examples, the immersive imagery engine 1120 may generate associations between virtual objects and linked scenes using metadata, object identifiers, or user-specified instructions. These associations may define which embedded objects serve as interactive portals into additional 3D reconstructed scenes 1144. When the user selects such a portal object, the immersive imagery engine 1120 may initiate a transition animation, load the associated 3D reconstructed scene 1144, and render the new environment within the immersive interface of the XR device 1102a. The transition may preserve orientation, depth cues, and lighting continuity to provide a smooth visual experience.

In some examples, the application 1112 may present a hierarchical or branching arrangement of 3D reconstructed scenes 1144, enabling the user to navigate between locations or objects by selecting embedded markers. For example, the user may begin with an exterior environment, select a marker representing an entrance, transition to an interior 3D reconstructed scene 1144, and then further select additional embedded objects to explore deeper levels of the environment. In other examples, the user may begin in a virtual environment generated by a user prompt 1126 and select embedded objects within that environment to explore related or nested virtual scenes generated by the immersive imagery engine 1120.

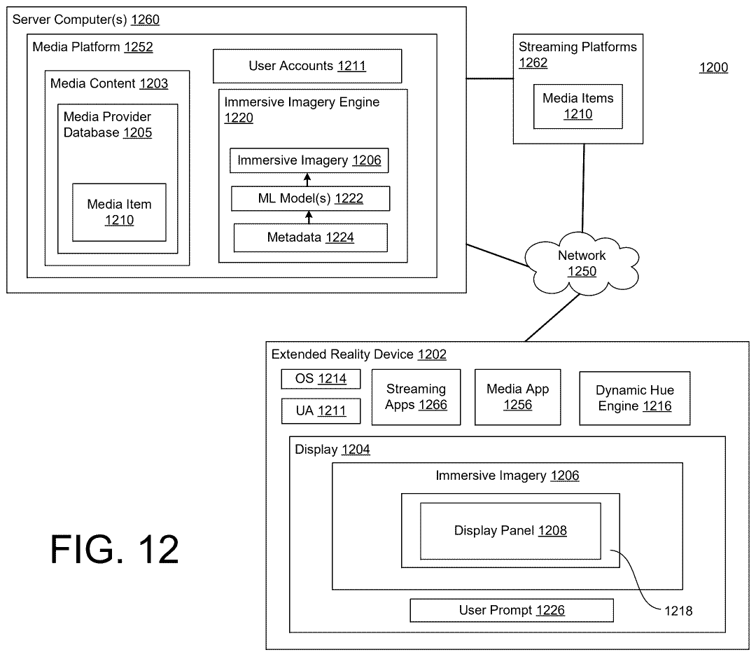

FIG. 12 illustrates a system 1200 for generating immersive imagery 1206 themed to a media item 1210 according to an aspect. The system 1200 may be an example of the systems and components of the previous figures and may include any of the details discussed with reference to the previous figures.

The system 1200 includes a media platform 1252 executable by one or more server computers 1260 and a media application 1256 executable by an XR device 1202. The media platform 1252 may be a server-based television or streaming platform. In some examples, the media application 1256 is (or is a subcomponent of) an operating system 1214 of the XR device 1202. In some examples, the media application 1256 is referred to as a host application.

In some examples, the media application 1256 is a native application (e.g., a standalone native application), which is preinstalled on the XR device 1202 or downloaded to the XR device 1202 from a digital media store (e.g., play store, application store, etc.). The media application 1256 may communicate with the media platform 1252 to identify media content 1203 that is available for streaming to the XR device 1202. The media content 1203 includes a plurality of media items 1210. In some examples, the media content 1203 includes media items 1210 that are stored on the media platform 1252 and streamed from the media platform 1252 to the media application 1256. In some examples, the media content 1203 includes media items 1210 that are stored on one or more (other) streaming platforms 1262 and streamed from the streaming platforms 1262 to their respective streaming applications 1266.

In some examples, the media application 1256 is a media aggregator application that determines which providers (e.g., streaming platforms 1262, associated streaming applications 1256) the user has access rights to, and then identifies media items 1210, across those providers, in a user interface for selection and playback. For example, the media application 1256 (e.g., in conjunction with the media platform 1252) may aggregate (e.g., combine, assemble, collect, etc.) information about media content 1203 available for viewing (e.g., streaming) from multiple streaming platforms 1262 and present the information in the user interface (e.g., a single, unified user interface) so that a user can identify and/or search media content 1203 across different streaming platforms 1262 (e.g., without having to search within each streaming application 1266). In some examples, the media content 1203 is referred to as media items 1210 (e.g., individual programs offered by streaming platforms 1262 and/or the media platform 1252). For example, each media item 1210 may be a program (e.g., a television show, a movie, a live broadcast, etc.) from the media platform 1252 or another streaming platform 1262. Instead of searching for media items 1210 on a first streaming application and separately searching for media items 1210 on a second streaming application, the media application 1256 may combine the media items 1210 together in one interface (e.g., a tabbed interface) so that a user can search across multiple streaming platforms 1262 at once.

In some examples, a media item 1210 may correspond to a digital video file, which may be stored on the streaming platforms 1262 (including the media platform 1252) and/or the XR device 1202. In some examples, the media platform 1252 is also considered a streaming platform 1262, which may store and provide digital video files for streaming or downloading. The digital video file may include video and/or audio data that corresponds to a particular media item 1210. In some examples, the media platform 1252 is configured to communicate with the streaming platforms 1262 to identify which media content 1203 is available on the streaming platforms 1262 and may update a media provider database 1205 to identify the media items 1210 offered by the streaming platforms 1262.

For example, the media platform 1252 may communicate, over a network 1250, with the streaming platforms 1262 to identify which media content 1203 is available to be streamed by XR devices 1202 and update a media provider database 1205. The media platform 1252 may identify a set or multiple sets of media items 1210 (e.g., across the various streaming platforms 1262) as recommendations to a user of the media application 1256. In some examples, the media platform 1252 may determine whether the user of the media application 1256 has rights (e.g., stored as entitlement data) to stream media content 1203 from one or more of the streaming platforms 1262 (e.g., whether the user has subscribed to access media content 1203 from the streaming platform(s) 1262), and, if so, may include those media items 1210 as candidates in a selection (e.g., ranking) mechanism to potentially be displayed in the user interface of the media application 1256.

The media application 1256 includes a user interface that identifies media items 1210 for selection and playback on the XR device 1202. In response to selection of a media item 1210, the media application 1256 may initiate playback of the media item 1210 on a display 1204 of the XR device 1202. In some examples, in response to selection of the media item 1210, the media platform 1252 streams the media item 1210 to the media application 1256, which causes the media application 1256 to display the media item 1210 on the display 1204. In some examples, in response to selection of the media item 1210 from the user interface of the media application 1256, the media application 1256 causes the content's underlying streaming application 1266 to playback the media item 1210.

In some examples, selection of a media item 1210 from the user interface may cause the media application 1256 to launch a streaming application 1266 (e.g., using a content deep link) associated with the streaming application 1266. In some examples, selection of a media item 1210 from the user interface causes the media application 1256 to render another user interface (e.g., item's landing page), and further selection of the media item 1210 from the item's landing page causes the media application 1256 to launch the underlying streaming application 1266. In some examples, the media item 1210 may be associated with a specific provider in which the media item 1210 is streamed from a streaming platform 1262 (e.g., the media platform 1252 itself or another streaming platform 1262). In some examples, the user can control the playback of the media item 1210 from the corresponding streaming application 1266.

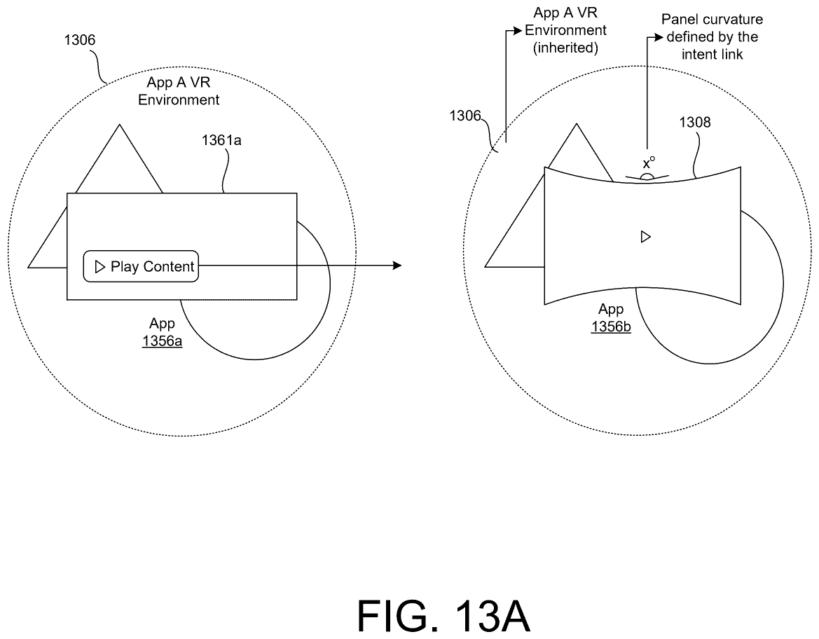

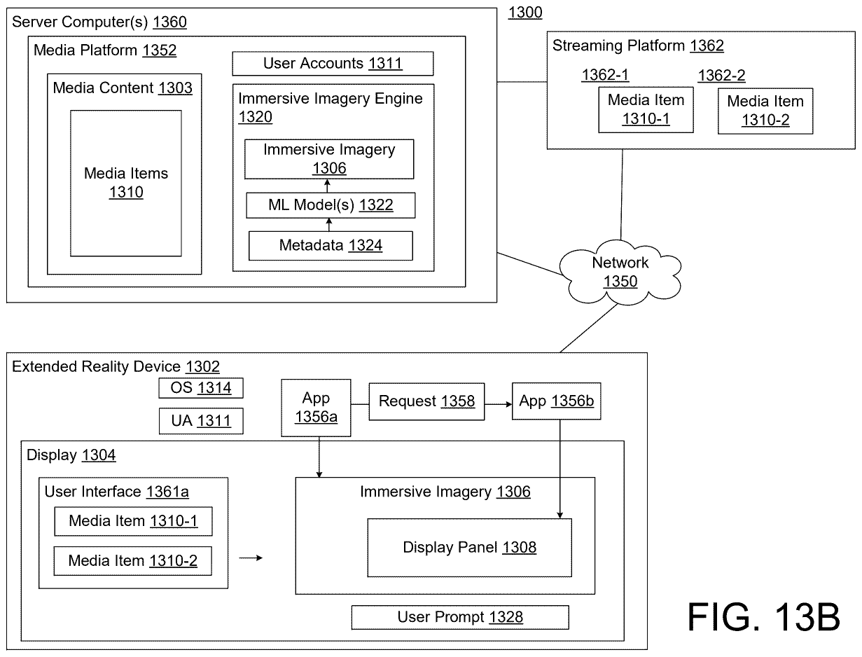

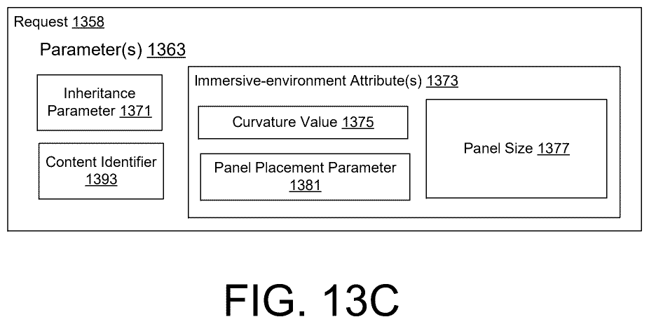

In some examples, the media application 1256 may transfer a content identifier (e.g., a content identifier 1393 of FIG. 13C) to the corresponding streaming application 1266. In some examples, the content identifier may be referred to as a content deep link. The content identifier may be an identifier that identifies the location of the media item 1210 in the streaming application 1266. The media application 1256 may transfer the content identifier to the corresponding streaming application 1266. In some examples, the content identifier identifies a specific landing page (e.g., an interface) within the streaming application 1266 that corresponds to the media item 1210. In some examples, the content identifier is an operating system intent. In some examples, the content identifier is a uniform resource locator (URL). In some examples, the content identifier includes a URL format.

Streaming (or playback) of the media item 1210 may refer to the transmission of the contents of a video file (e.g., media assets) from a streaming platform 1262 or the media platform 1252 to the XR device 1202 that displays the contents of the video file via a display panel 1208 (e.g., a video player window). In some examples, streaming (or playback) of the media item 1210 may refer to a continuous video stream that is transferred from one place to another place in which a received portion of the video stream is displayed while waiting for other portions of the video stream to be transferred. In some examples, after the media item 1210 is published on the media platform 1252 (e.g., is live), the XR device 1202 may stream or download the contents of the video file.

In some examples, the user interface of the media application 1256 may identify a plurality of media items 1210, which may be selected by the media platform 1252 from the media provider database 1205 based at least in part on information representing the user's interests and activities (e.g., the user's search queries, search results, previous watch history, purchase history, application usage history, application installation history, user actions on the network-connected display device, physical activities of the user, etc.). In some examples, the media application 1256 may be associated with a user account 1211, and the user account 1211 may store the information representing the user's interests and activities (e.g., user activity information), and the media platform 1252 may use this information to select and present the media items 1210 in the user interface. In some examples, the media items 1210 may be organized as a plurality of clusters based on one or more categories, such as content type (e.g., “Action Movies”), viewing history (e.g., “Because You watched Movie ABC”), release time (e.g., “Trending”), and the like. In some examples, the media items 1210 provided by different streaming platforms 1262 (e.g., action movies from two different streaming platforms 1262) can be recommended in the same cluster. In some examples, the user interface may include tabbed interfaces, where one of the tabbed interfaces includes personalized media content that is organized as a plurality of clusters based on one or more categories, such as release time (e.g., “This Week,” “Next week,” “Next Month,” etc.), user action and user application interaction, native app usage (e.g., items that are “From App ABC”), etc.

It is noted that a user of the media application 1256 may be provided with controls allowing the user to make an election as to both if and when the system 1200 may enable the collection of information representing the user's interests and activities. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user of the media application 1256 may have control over what information is collected about the user, how that information is used, and what information is provided to the user and/or to the server computer 1260.

The media platform 1252 may store user accounts 1211, where each user account 1211 stores information about a respective user. A user account 1211 may store entitlement data and/or user activity information. The entitlement data includes information that identifies which providers (e.g., streaming platforms 1262, streaming applications 1266) that the user account 1211 has access rights to view content. In some examples, the access rights are determined based on the user account 1211 (e.g., whether the user has subscribed to one or more streaming applications 1266), which streaming applications 1266 are installed on the XR device 1202 and/or if the user has accessed (e.g., logged-into) a user account associated with those streaming applications 1266. In response to certain user activity regarding media items 1210, the media platform 1252 may update the user activity information with information about the activity such as a content identifier, the date/time, and/or the watch duration of the media item 1210, etc.

In some examples, the system 1200 includes an immersive imagery engine 1220, which may be part of the media platform 1252 or stored on a server computer 1260 that is separate from the media platform 1252. The immersive imagery engine 1220 is configured to generate immersive imagery 1206 for display on the XR device 1202. In some examples, at least a portion of the immersive imagery engine 1220 may be stored on the XR device 1202.

The immersive imagery engine 1220 generates immersive imagery 1206 themed to a media item 1210, and the XR device 1202 may receive and display the immersive imagery 1206 as background for a display panel 1208 that displays the 2D content of the media item 1210. The display panel 1208 may be referred to as a video player window. The display panel 1208 can display a video or an image. In some examples, the display panel 1208 displays 2D content.

In some examples, the immersive imagery 1206 includes a panoramic image with a wide field of view (e.g., a 360-degree field of view). In some examples, the immersive imagery 1206 includes a 360-degree skybox image. A 360-degree skybox image may be a panoramic image that surrounds the user's field of view, creating an immersive virtual environment. As the user manipulates the XR device 1202 (e.g., rotating and/or titling the user's head), the panoramic image shifts accordingly, thereby giving the user the sensation of being within the scene represented by the immersive imagery 1206.

In some examples, the XR device 1202 includes a dynamic hue engine 1216 configured to render a visual effect 1218 (e.g., at least partially around or fully around) the display panel 1208. In some examples, the visual effect 1218 includes a dynamic display of colored flares or haloes that change color in real-time to match the dominant hues in the media item 1210. In some examples, the visual effect 1218 is referred to as a dynamic hue screen extension. In some examples, the visual effect 1218 includes adaptive virtual color flares surrounding the display panel 1208 in which the media item is being viewed (“extended screen”). The virtual color flares may change based on the colors in the content (e.g., a gardening “how to” video may cause the dynamic hue engine 1216 to display adaptive green flares surrounding the display panel 1208). The dynamic hue engine 1216 analyzes the color content of the video or image being played and then generates the visual effect 1218 around the display panel 1208. The visual effect 1218 may include the display of colored flares or halos that change color in real-time to match the dominant hues in the playback content.

In some examples, instead of displaying the immersive imagery 1206 on a display 1204 of the XR device 1202, the XR device 1202 may enable the selection of an augmented reality (AR) mode, which passes through the user's surroundings. For example, in the AR mode, the XR device 1202 may display pass-through video of the user's surroundings in the XR environment, and the display panel 1208 may be positioned in the user's space in the extended reality environment. In some examples, the dynamic hue engine 1216 may adjust the hue of the user's passthrough surroundings to correspond to (e.g., match) the color themes of the content being displayed on the display panel 1208. In some examples, the dynamic hue engine 1216 may analyze the video content being played to determine its dominant colors and overall color palette and perform color filtering on the device's display by filtering the light emitted by the display's pixels. The XR device 1202 includes a camera system configured to capture the user's surroundings. In some examples, the dynamic hue engine 1216 may use the color information from the video content to adjust the color of the images captured by the camera system.

In some examples, the XR device 1202 renders an interface (e.g., a prompt interface) to receive a user prompt 1226 (e.g., verbal or text) (e.g., a natural language query) to adjust the immersive imagery 1206 or to create a new (e.g., user-specific or custom) immersive imagery 1206, which may include changing a portion or an aspect of the immersive imagery 1206, generating new immersive imagery 1206, and/or animating one or more elements in the immersive imagery 1206 and/or adding one or more virtual objects. For example, a user may submit a user prompt 1226 (e.g., via voice or text) (e.g., animate the leaves, enlarge the stars, make brighter). In response to the user prompt 1226, the immersive imagery engine 1220 may re-generate immersive imagery 1206 using the user prompt 1226 and the previous panoramic images. In other words, the immersive imagery engine 1220 may enable the generation of custom immersive imagery 1206. In some examples, the custom immersive imagery 1206 may be saved by storing the custom immersive imagery 1206 in data storage, e.g., in association with a user account 1211. In some examples, the user may share the immersive imagery 1206 with other users of XR devices 1202 and/or the media platform 1252.

The immersive imagery engine 1220 may include one or more machine-learning (ML) models 1222 (e.g., generative models such as text-to-text generative models, text-to-image generative models, image-to-image generative models and/or multi-modality generative models that can receive text, audio, and/or image in a prompt as an input, and generate text, audio, and/or an image as an output. In some examples, the immersive imagery engine 1220 may generate a panoramic image (e.g., a wide image such as a 360-degree image) from a text prompt or a prompt with text, image, and/or video. In some examples, the immersive imagery engine 1220 may include a 2D-to-360 image pipeline. The 2D-to-360 degree image pipeline may include a plurality of layers such as prompt engineering, base image generation, field of view extension, upsampling, and/or hue extension.

In some examples, the immersive imagery engine 1220 may generate immersive imagery 1206 based on metadata 1224 associated with the media item 1210. In some examples, the metadata 1224 may include textual data about the media item 1210 such as one or more portions of information of an entity page provided by the media platform 1252, a resource locator associated with the media item 1210, caption data from the media item 1210, and/or a description of the media item 1210. In some examples, the metadata 1224 includes video samples (or image samples) and/or audio samples from the media item 1210. In some examples, the immersive imagery engine 1220 may generate an immersive imagery 1206 based on the user prompt 1226 received via a prompt interface.

FIGS. 13A to 13C illustrate a system 1300 including an extended reality device 1302 for enabling an application 1356b to use immersive imagery 1306 provided by an application 1356a for streaming a media item 1310 by the application 1356b. The system 1300 may be an example of the previous systems described herein and may include any of the details discussed herein including the selection and/or generation of the immersive imagery discussed with reference to FIGS. 1A to 12. In some examples, the application 1356a is referred to as a host application, and the application 1356b is referred to as a streaming application. A host application may refer to an application executing on the extended reality device that is currently rendering or controlling an immersive environment (e.g., the immersive imagery 1306) at the time a user selects a media item 1310 for playback. A streaming application may refer to an application selected to play or stream the media item 1310 and that is launched in response to the user's selection. The streaming application may inherit and reuse the immersive imagery 1306 established by the host application based on parameters included within the request 1358.

In some examples, the system 1300 enables the transfer of one or more parameters 363 from the application 1356a to the application 1356b using a request 1358. The request 1358 may include one or more parameters 1363 such as an inheritance parameter 1371, a content identifier 1393, and/or one or more immersive-environment attributes 1373. The immersive-environment attribute(s) 1373 may include a curvature value 1375, a panel size 1377, and/or a panel placement parameter 1381. By allowing the application 1356b to inherit immersive imagery 1306 and the immersive-environment attributes 1373, the system 1300 provides technical benefits including reduced re-computation of immersive imagery 1306, reduced transition latency between applications, and/or preservation of the immersive environment as the user moves from the interface of the application 1356a into the playback experience of the application 1356b. This may improve cross-application interoperability, reduce processing load on the extended reality device, and/or yield a seamless immersive viewing experience.

The system 1300 includes a media platform 1352 executable by one or more server computers 1360 and an application 1356a executable by an XR device 1302. The media platform 1352 may be a server-based television or streaming platform configured to communicate with the application 1356a over a network 1350. In some examples, the application 1356a is (or is a subcomponent of) an operating system 1314 of the XR device 1302. In some examples, the application 1356a is a native application (e.g., a standalone native application), which is preinstalled on the XR device 1302 or downloaded to the XR device 1302 from a digital media store (e.g., play store, application store, etc.). The application 1356a may communicate with the media platform 1352 to identify media content 1303 that is available for streaming to the XR device 1302.

The media content 1303 includes a plurality of media items 1310. In some examples, the media content 1303 includes media items 1310 that are stored on the media platform 1352 and streamed from the media platform 1352 to the media application 1356a. In some examples, the media content 1303 includes media items 1310 that are stored on one or more (other) streaming platforms 1362 (e.g., streaming platform 1362-1, streaming platform 1362-2) and streamed from the streaming platforms 1362 to their respective streaming applications (e.g., application 1356b). In some examples, the application 1356a may be associated with a user account 1311, and the user account 1311 may store the information representing the user's interests and activities (e.g., user activity information), and the media platform 1352 may use this information to select and present the media items 1310 in the user interface 1361a.

In some examples, the application 1356a is a media aggregator application that aggregates media items 1310 (e.g., media item 1310-1, media item 1310-2) across streaming platforms 1362 (e.g., streaming platform 1362-1, streaming platform 1362-2) in a unified user interface (e.g., user interface 1361a). The selection of a media item 1310 from the application 1356a causes the application 1356a to launch the corresponding streaming application (e.g., application 1356b) to play back the media item 1310. In some examples, a media item 1310 available for selection in the application 1356a has immersive imagery 1306 generated by an immersive imagery engine 1320. In some examples, the immersive imagery engine 1320 may include one or more ML models 1322 that generate immersive imagery 1306 from metadata 1324 associated with the media item 1310. In response to selection of the media item 1310, in some examples, the application 1356a may display a dialog that asks the user whether they wish to watch the media item 1310 in a themed cinema.

In response to user interaction with a control that selects a themed cinema environment, the application 1356a (e.g., application A) may initiate operations that cause a second application 1356b (e.g., application B) to inherit the immersive imagery 1306 originally established by the application 1356a. When the control is selected, the application 1356a may create or activate an activity that renders the immersive imagery 1306 on the display 1304. As used herein, the term immersive imagery 1306 may refer to a digitally generated three-dimensional or panoramic environment that is rendered as the spatial background or surround environment for one or more display panels 1308 and/or other examples as discussed with reference to the previous figures. In some examples, the application 1356b is a streaming application that is distinct (e.g., different from) the application 1356a. For examples, the applications 1356a, 1356b are different streaming applications owned or managed by separate organizational entities.

After generating or activating this immersive imagery 1306, the application 1356a may transmit a request 1358 to the application 1356b. The request 1358 may refer to a data structure generated at the application layer or at the operating system layer that includes parameters, metadata, and/or indicators used by the system 1300 to configure how the application 1356b is launched or transitioned into the immersive imagery 1306. In some examples, the request 1358 is an operating-system-level request. In other examples, the request 1358 is implemented using an intent or an intent-based request.

The request 1358 includes an inheritance parameter 1371 that specifies whether the receiving application (e.g., application 1356b) should be launched in a mode that preserves the immersive imagery 1306 that is currently active in the context of the application 1356a. The inheritance parameter 1371 functions as a system-level directive processed by the operating system 1314 to instruct the immersive-environment subsystem to retain the immersive imagery 1306 rather than clearing or resetting the environment during application switching. When the inheritance parameter 1371 is enabled, the system 1300 maintains the existing immersive imagery 1306 throughout the launch sequence of the application 1356b, allowing the application 1356b to begin execution within the same immersive context that was established by the application 1356a. As a result, the application 1356b appears to seamlessly inherit the immersive imagery 1306 without independently regenerating, re-initializing, or re-requesting the immersive environment. In some examples, maintaining the immersive imagery 1306 includes suspending teardown routines associated with exiting application 1356a, preserving GPU-level scene buffers or skybox textures, and propagating immersive-environment attributes 1373 (e.g., curvature value 1375, panel size 1377, or panel placement parameter 1381) to the execution environment of the application 1356b such that the immersive imagery 1306 remains continuous and visually stable during the transition.

The request 1358 may additionally include one or more immersive-environment attributes 1373, which represent environment-defining parameters used by the system 1300 and the application 1356b to configure how content is placed, shaped, and/or displayed within the immersive imagery 1306.

In some examples, the immersive-environment attributes 1373 include a curvature value 1375 for the display panel 1308. The curvature value 1375 represents a parameter that defines a curvature radius or curvature configuration to be applied to the display panel 1308 inside the immersive imagery 1306. By specifying a particular radius or curvature setting, the curvature value 1375 determines whether the display panel 1308 is rendered as a flat surface, a slightly curved panoramic surface, or a deeply curved cinema-style surface within the immersive imagery 1306. When the application 1356b receives the request 1358 containing the curvature value 1375, the application 1356b interprets the curvature value 1375 as a geometry-defining instruction and configures its rendering pipeline so that the display panel 1308 is generated with a surface profile corresponding to the curvature value 1375. In particular, the shaders, surface-mesh generation routines, and depth-projection parameters used by the application 1356b may be updated to ensure that the display panel 1308 visually conforms to the thematic or cinematic characteristics of the immersive imagery 1306 originally established by the application 1356a. This enables the application 1356b to integrate seamlessly into the inherited environment by matching geometric cues such as wrap-around depth, parallax curvature, and peripheral-vision shaping that contribute to the overall immersive experience.

In some examples, the immersive-environment attributes 1373 include a panel size 1377 for the display panel 1308. The panel size 1377 is a parameter that defines one or more spatial dimensions of the display panel 1308, such as an absolute or relative width, height, aspect ratio, or scale factor used to size the display panel 1308 within the immersive imagery 1306. In some examples, the panel size 1377 represents a normalized scale value that the application 1356b applies to a base panel geometry, while in other examples, the panel size 1377 specifies explicit dimensional values that the application 1356b uses to construct a rendering surface of corresponding physical size in the virtual environment. The application 1356b may use the panel size 1377 when generating, updating, or re-parenting the display panel 1308 to ensure that the visual footprint of the display panel 1308 appropriately fits the immersive imagery 1306, such as by maintaining consistency with the themed cinema layout, matching the user's expected viewing distance, or preserving a preferred cinematic screen size defined by the application 1356a. In some examples, the panel size 1377 allows the application 1356b to align its display panel 1308 with the spatial characteristics of the inherited immersive imagery 1306 without recomputing environment-dependent scaling rules, thereby facilitating seamless cross-application transitions where the viewing surface appears stable and continuous from the perspective of the user.

In some examples, the immersive-environment attributes 1373 include a panel placement parameter 1381, which defines how and where the display panel 1308 is positioned within the immersive imagery 1306. The panel placement parameter 1381 may specify an absolute spatial location or a position relative to one or more reference points within the immersive environment, such as the center of the user's field of view, a virtual surface, or a thematic anchor point defined by the immersive imagery 1306.

The panel placement parameter 1381 may encode positional coordinates (e.g., three-dimensional X, Y, Z coordinates), orientation values such as rotation angles or quaternions, and directional vectors that specify the alignment or facing direction of the display panel 1308. In some examples, the panel placement parameter 1381 includes anchoring or attachment information that identifies a virtual surface or region within the immersive imagery 1306 to which the panel should be affixed, ensuring that the panel 1308 remains visually consistent with the themed cinema or other immersive setting selected by the user. During execution of the application 1356b, the panel placement parameter 1381 enables the system 1300 to recreate the spatial layout intended by the application 1356a, making the display panel 1308 appear seamlessly embedded within the inherited immersive environment without requiring the second application to recompute or infer the intended spatial configuration.

In some examples, the immersive-environment attributes 1373 may further include environmental illumination parameters that specify lighting intensity, ambient color, contrast values, or other scene-illumination characteristics that affect how the display panel 1308 and the immersive imagery 1306 are jointly rendered. The immersive-environment attributes 1373 may also include environmental audio parameters that define spatial audio positioning, reverberation characteristics, or sound field profiles that are associated with the immersive imagery 1306. In additional examples, the immersive-environment attributes 1373 may include depth-of-field parameters indicating focal distances or blur radii to be applied to the immersive imagery 1306, thereby allowing the application 1356b to match the cinematic presentation style originally established by the application 1356a. By including these additional immersive-environment attributes 1373 in the request 1358, the system 1300 enables the application 1356b to duplicate, inherit, or align with the rendering configuration of the immersive imagery 1306, producing a seamless visual and auditory experience across applications.

In some examples, the system 1300 enables the inheritance behavior by maintaining the immersive imagery 1306 in an active rendering session during a transition from the application 1356a to the application 1356b. In some examples, the request 1358 is transmitted before the application 1356a terminates or yields control, allowing the operating system to preserve the immersive imagery 1306 as an active environment layer. The operating system may then launch the application 1356b into the preserved immersive imagery 1306 using the inheritance parameter 1371 and the immersive-environment attributes 1373 included in the request 1358. In some examples, the operating system converts the request 1358 into a set of activity-launch parameters used by the system compositor, immersive-mode controller, or rendering subsystem to keep the immersive imagery 1306 active while replacing only the application-specific display panel 1308 with a new display panel 1308 generated by the application 1356b. This technique may provide one or more technical benefits of reducing transition latency, avoiding re-creating the immersive imagery 1306, and providing the appearance that the application 1356b naturally continues within the same immersive environment previously established by the application 1356a.

In some examples, the transmission of the request 1358 occurs prior to termination of a rendering session of the application 1356a such that the immersive imagery 1306 is maintained during launch of the application 1356b. For example, the transmission of the request 1358 may occur prior to termination of a rendering session of the application 1356a so that the immersive imagery 1306 remains active and uninterrupted during the launch of the application 1356b. Maintaining the rendering session of the application 1356a may ensure that the immersive imagery 1306 is not destroyed, faded out, re-initialized, or replaced by a default environment before the system 1300 transfers control to the application 1356b. By sending the request 1358 while the immersive imagery 1306 is still actively rendered, the system 1300 is able to treat the immersive environment as a shared, inheritable resource rather than a resource bound exclusively to the lifecycle of the application 1356a. This preserves continuity between application transitions, minimizes perceptible visual changes, reduces load on the rendering subsystem by preventing redundant environment reconstruction, and allows the application 1356b to enter (e.g., enter directly) into the immersive imagery 1306 as though the environment were originally instantiated for its own session.

In some examples, the immersive imagery engine 1320 generates the immersive imagery 1306 based on metadata associated with the media item 1310. In some examples, the immersive imagery engine 1320 may receive a user prompt 1328 and re-generate the immersive imagery 1306 based on the user prompt 1328.

In some examples, the immersive imagery engine 1320 generates the immersive imagery 1306 based on metadata associated with the media item 1310. The metadata may describe thematic characteristics, genre indicators, color palettes, spatial layout descriptors, or environmental tags associated with the media item 1310, and the immersive imagery engine 1320 may use such metadata to select or synthesize an immersive environment whose visual and spatial properties complement the media item 1310. In some examples, the immersive imagery engine 1320 may receive a user prompt 1328, which may represent a user-selected thematic preference, environmental adjustment, or style modification, and the immersive imagery engine 1320 may re-generate the immersive imagery 1306 based on the user prompt 1328. The regeneration may involve updating one or more immersive-environment attributes 1373, such as reconfiguring panel curvature, adjusting the virtual lighting or ambiance, selecting an alternate 3D reconstructed scene, or modifying spatial placement of components within the immersive imagery 1306. In this manner, the immersive imagery engine 1320 dynamically adapts the immersive environment in response both to the semantic properties of the media item 1310 and to direct user input, thereby enabling the immersive imagery 1306 to remain contextually relevant and responsive to user preferences.

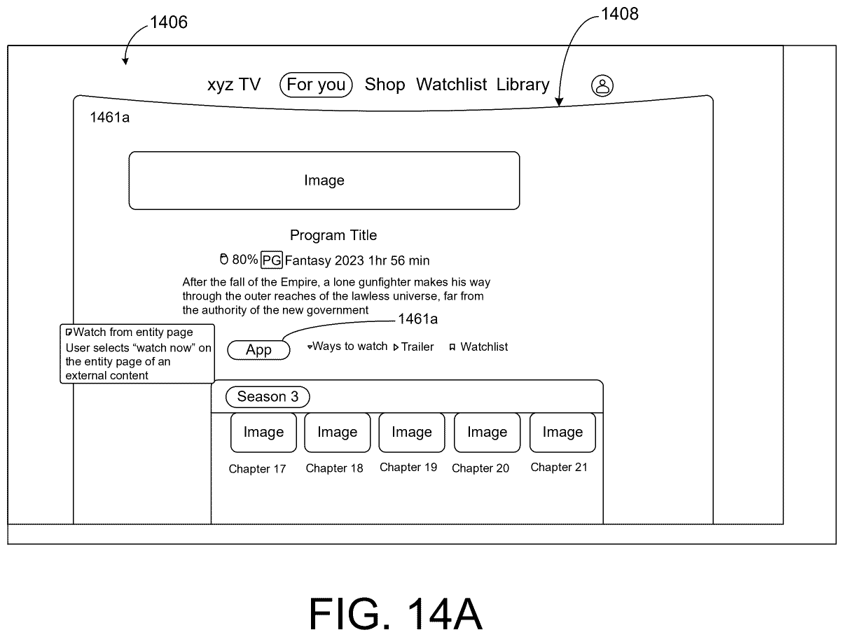

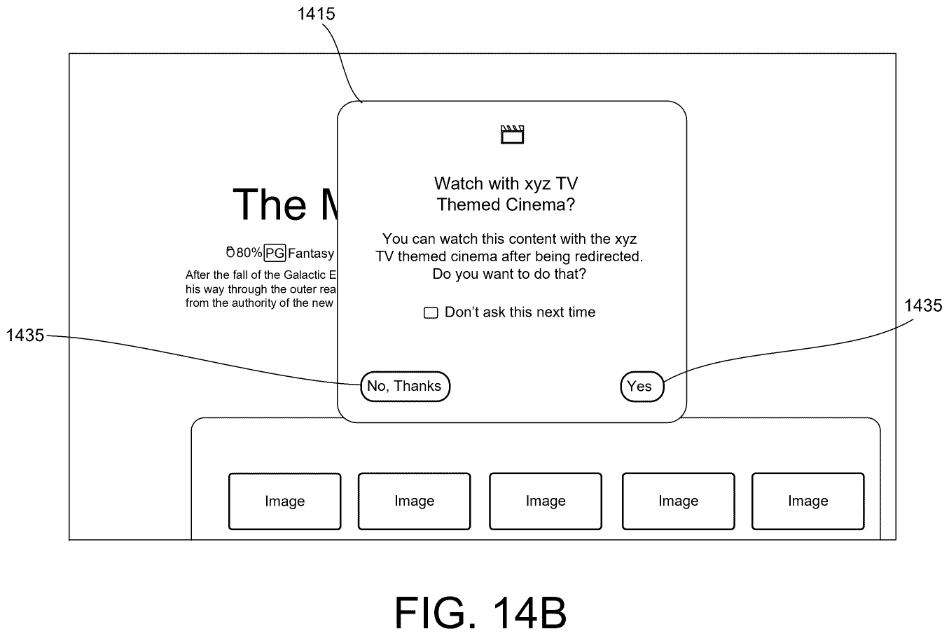

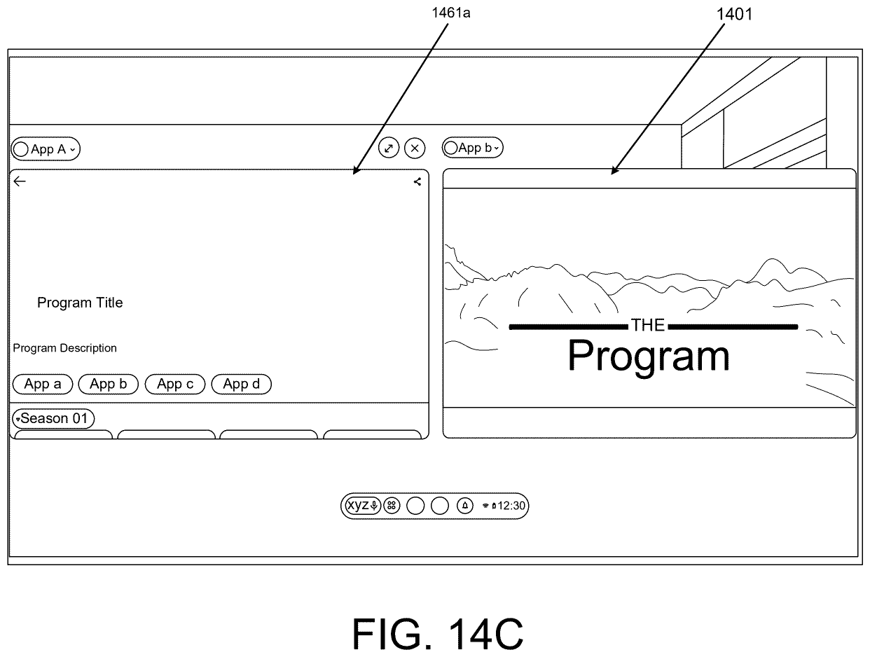

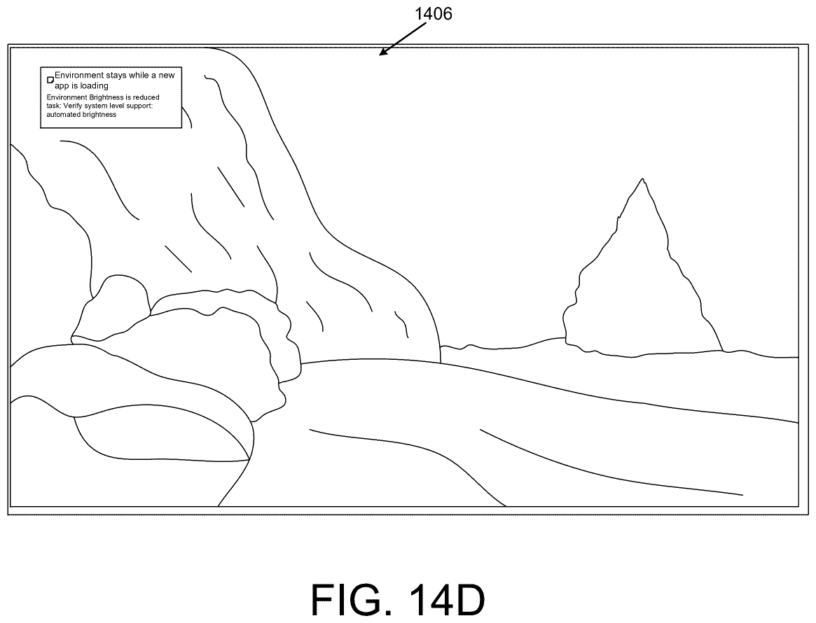

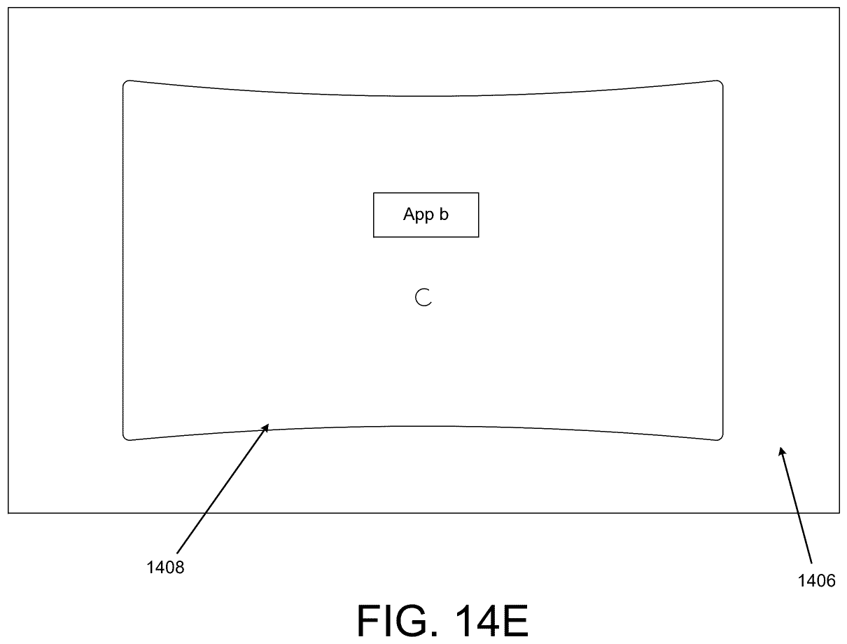

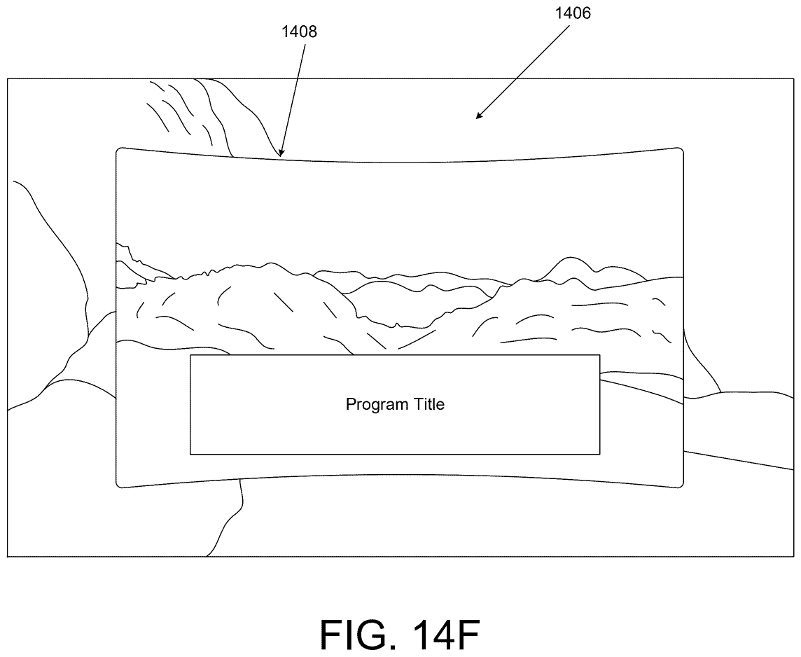

FIGS. 14A to 14F illustrate various interfaces for the system 1300 of FIGS. 13A to 13C and demonstrate how the immersive imagery 1406 can be transitioned, inherited, and reused as the user moves between different applications.

As shown in FIG. 14A, the immersive imagery 1406 is rendered as a background environment surrounding a display panel 1408 through which a user interface 1461a of a media application is presented. This initial interface allows the user to browse or preview the media item within a spatially rich backdrop. In response to a user selection that indicates interest in streaming the media item through another streaming application, the system presents a UI object 1415, as shown in FIG. 14B. The UI object 1415 communicates that a themed cinema experience is available and introduces controls that guide the user into the immersive playback workflow. The UI object 1415 may include a control 1435 that, when selected, instructs the media application to update the interface to that shown in FIG. 14C, where the user interface 1461a is rendered alongside a video player 1401 that is launched by the corresponding streaming application. The UI object 1415 may additionally include another instance of the control 1435 which, when selected, causes the system to transition the user into the interface shown in FIG. 14D, where the immersive imagery 1406 is prominently displayed without the media application's browsing interface.

As shown in FIGS. 14E and 14F, following this transition, a display panel 1408 associated with the selected streaming application is launched within the context of the immersive imagery 1406, giving the appearance that the display panel 1408 has been seamlessly integrated into the themed cinema environment originally established by the media application. This set of interfaces demonstrates a UI flow: from the initial immersive backdrop, to discovery of a themed cinema option, to handoff between applications, and finally to the rendering of the display panel 1408 within the inherited immersive imagery 1406.

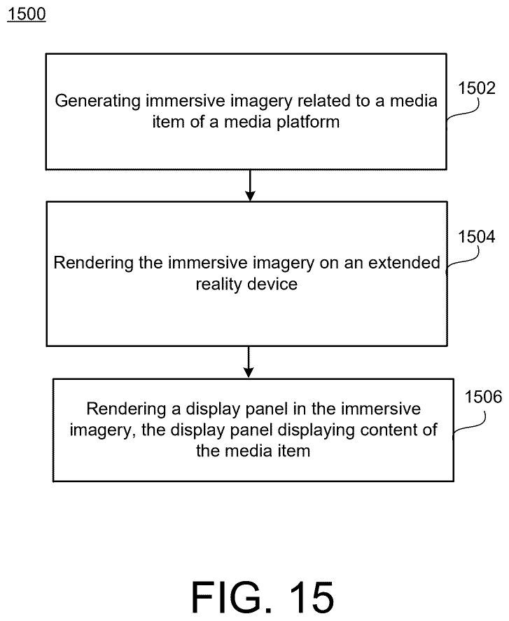

FIG. 15 is a flowchart 1500 depicting example operations of a system for generating and/or rendering immersive imagery. The flowchart 1500 may depict operations of a computer-implemented method. The flowchart 1500 may be applicable to any of the implementations discussed herein. Although the flowchart 1500 of FIG. 15 illustrates the operations in sequential order, it will be appreciated that this is merely an example, and that additional or alternative operations may be included. Further, operations of FIG. 15 and related operations may be executed in a different order than that shown, or in a parallel or overlapping fashion.

Operation 1502 includes generating immersive imagery related to a media item of a media platform. Operation 1504 includes rendering the immersive imagery on an extended reality device. Operation 1506 includes rendering a display panel in the immersive imagery, the display panel displaying content of the media item.

By generating immersive imagery in association with a media item before or during the rendering of the primary user interface, the system can prepare a spatially coherent background environment that is available (e.g., immediately available) when a display panel is introduced. This reduces the amount of re-computation required at launch time, minimizes loading delays, and/or simplifies transitions between application contexts. Rendering the immersive imagery directly on the extended reality device also allows the device to optimize shading, geometry processing, and projection based on the user's current pose, thereby improving rendering responsiveness and/or reducing unnecessary updates to the environment.

Further, rendering the display panel within the immersive imagery, rather than as a separate 2D overlay, produces a technically improved presentation layer. Because the display panel is spatially integrated into the immersive environment, the system can maintain consistent depth cues, lighting conditions, and panel orientation relative to the user's viewpoint, reducing perceptual discontinuities that often occur when flat media panels are composited over independent backgrounds. Integrating the display panel into the scene also allows downstream applications—such as a media application that takes over playback—to reuse the existing immersive imagery without reinitializing a separate environment. This reuse lowers memory consumption, reduces the number of GPU context switches, and avoids unnecessary teardown and recreation of scene graph elements. As a result, the extended reality device achieves smoother transitions, lower latency, and an improved user experience while also reducing the overall computational workload.

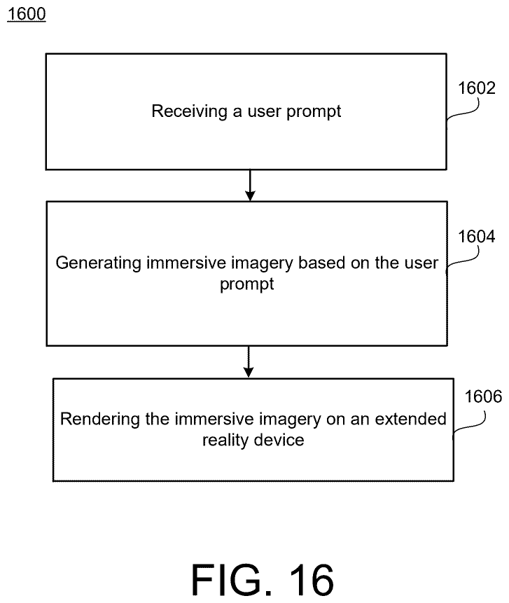

FIG. 16 is a flowchart 1600 depicting example operations of a system for generating and/or rendering immersive imagery. The flowchart 1600 may depict operations of a computer-implemented method. The flowchart 1600 may be applicable to any of the implementations discussed herein. Although the flowchart 1600 of FIG. 16 illustrates the operations in sequential order, it will be appreciated that this is merely an example, and that additional or alternative operations may be included. Further, operations of FIG. 16 and related operations may be executed in a different order than that shown, or in a parallel or overlapping fashion.

Operation 1602 includes receiving a user prompt. Operation 1604 includes generating immersive imagery based on the user prompt. Operation 1606 includes rendering the immersive imagery on an extended reality device.

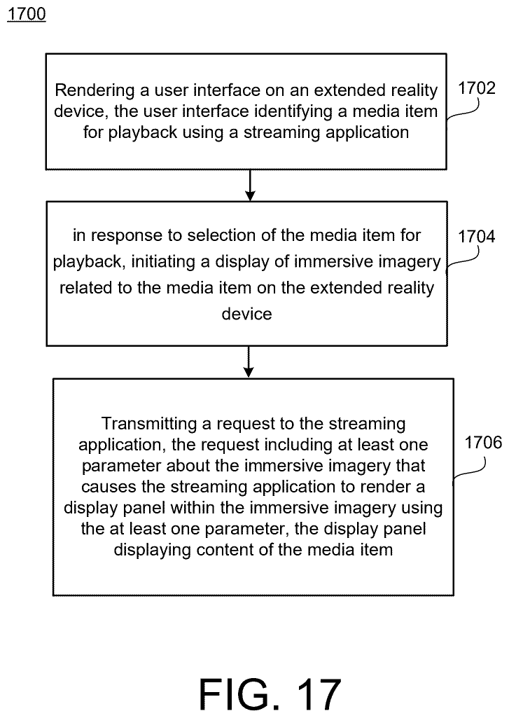

FIG. 17 is a flowchart 1700 depicting example operations of a system for generating and/or rendering immersive imagery. The flowchart 1700 may depict operations of a computer-implemented method. The flowchart 1700 may be applicable to any of the implementations discussed herein. Although the flowchart 1700 of FIG. 17 illustrates the operations in sequential order, it will be appreciated that this is merely an example, and that additional or alternative operations may be included. Further, operations of FIG. 17 and related operations may be executed in a different order than that shown, or in a parallel or overlapping fashion.

Operation 1702 includes rendering a user interface on an extended reality device, the user interface identifying a media item for playback using a streaming application. Operation 1704 includes, in response to selection of the media item for playback, initiating a display of immersive imagery related to the media item on the extended reality device. Operation 1706 includes transmitting a request to the streaming application, the request including at least one parameter about the immersive imagery that causes the streaming application to render a display panel within the immersive imagery using the at least one parameter, the display panel displaying content of the media item.

In some examples, the operations of FIG. 17 enable the extended reality device to provide the immersive imagery generated by a host application (e.g., a first application) as a persistent rendering context that survives the transition to the streaming application (e.g., a second application). When the user selects the media item within the user interface of the first application, the extended reality device maintains the rendering session in which the immersive imagery is produced, such that the immersive imagery continues to occupy the background or environmental layer of the user's field of view while the second application is launched. Because the request transmitted in operation 1706 includes environment-defining information describing the immersive imagery (e.g., such as curvature parameters, panel size parameters, panel placement parameters, and/or an inheritance indicator), the second application is able to initialize its rendering surface or display panel in a manner that conforms to the spatial, perceptual, and/or cinematic attributes established by the first application. In this way, the visual environment does not need to be re-constructed or re-initialized by the second application, which would normally require the second application to possess its own immersive-imagery generation logic.

The system therefore provides a cross-application visual context pipeline that allows an extended reality device to render two different applications within the same immersive scene without tearing down or rebuilding the immersive environment between application launches. This approach produces several technical advantages. Because the system maintains the rendering session of the first application and reuses the immersive imagery as a shared environment for the second application, the device reduces the computational burden associated with repeated scene loading, geometry construction, texture allocation, lighting computation, and environment-map generation. By avoiding a full teardown of the scene, the device minimizes visual discontinuities that would otherwise present as flashing, blanking, re-projection artifacts, or latency spikes associated with reinitializing the XR compositor. As a result, the user perceives a seamless transition in which the immersive imagery appears uninterrupted while the second application's display panel is inserted directly into the existing immersive environment. The technique improves responsiveness, lowers power consumption, and enhances user comfort by stabilizing the visual frame of reference during cross-application transitions within the extended reality environment.
Clause 1. A method comprising: generating immersive imagery related to a media item of a media platform; rendering the immersive imagery on an extended reality device; and rendering a display panel in the immersive imagery, the display panel displaying content of the media item.
Clause 2. The method of clause 1, further comprising: receiving a user prompt; and re-generating the immersive imagery based on the user prompt.
Clause 3. The method of clause 1 or 2, wherein the immersive imagery is first immersive imagery, the first immersive imagery including an interactive virtual object, the method further comprising: in response to a selection of the interactive virtual object from the first immersive imagery, replacing the first immersive imagery with second immersive imagery associated with the media item on the extended reality device.
Clause 4. The method of any one of clauses 1 to 3, further comprising: generating a summary caption based on metadata of the media item; generating a base image using the summary caption; and generating the immersive imagery using the base image.
Clause 5. The method of clause 4, further comprising: obtaining the metadata from an entity page associated with the media item.
Clause 6. The method of any one of clauses 1 to 5, wherein the extended reality device is a first extended reality device, the method further comprising: transmitting an identifier of the immersive imagery to a second extended reality device, the identifier configured to be used by the second extended reality device to display the immersive imagery on the second extended reality device.
Clause 7. The method of any one of clauses 1 to 6, further comprising: applying a visual effect to at least one of the immersive imagery or the display panel based on the content in the display panel.
Clause 8. The method of any one of clauses 1 to 7, wherein the immersive imagery includes one or more animated elements.
Clause 9. A non-transitory computer-readable medium storing executable instructions that when executed by at least one processor causes the at least one processor to execute operations, the operations comprising: generating immersive imagery related to a media item of a media platform; rendering the immersive imagery on an extended reality device; and rendering a display panel in the immersive imagery, the display panel displaying content of the media item.
Clause 10. The non-transitory computer-readable medium of clause 9, wherein the operations further comprise: receiving a user prompt; and re-generating the immersive imagery based on the user prompt.
Clause 11. The non-transitory computer-readable medium of clause 9 or 10,wherein the operations further comprise: determining a quality metric for the immersive imagery; and in response to the quality metric not satisfying a threshold, applying a hue extension effect to the display panel based on the content of the media item.
Clause 12. The non-transitory computer-readable medium of any one of clauses 9 to 11, wherein the immersive imagery includes a first panoramic image having an interactive virtual object, wherein the operations further comprise: in response to a selection of the interactive virtual object, rendering a second panoramic image.
Clause 13. The non-transitory computer-readable medium of any one of clauses 9 to 12, wherein the operations further comprise: applying a visual effect to the immersive imagery based on the content in the display panel.
Clause 14. The non-transitory computer-readable medium of any one of clauses 9 to 13, wherein the display panel includes a curved panel, wherein the curved panel is positioned within the immersive imagery according to a position associated with the media platform.
Clause 15. The non-transitory computer-readable medium of any one of clauses 9 to 14, wherein the operations further comprise: generating a summary caption based on metadata of the media item; generating a base image using the summary caption; and generating the immersive imagery using the base image.
Clause 16. The non-transitory computer-readable medium of any one of clauses 9 to 15, wherein the extended reality device is a first extended reality device, wherein the operations further comprise: transmitting an identifier of the immersive imagery to a second extended reality device, the identifier configured to be used by the second extended reality device to display the immersive imagery on the second extended reality device.
Clause 17. An extended reality device comprising: at least one processor; and a non-transitory computer-readable medium storing executable instructions that cause the at least one processor to: generate immersive imagery related to a media item of a media platform; render the immersive imagery on an extended reality device; and render a display panel in the immersive imagery, the display panel displaying content of the media item.
Clause 18. The extended reality device of clause 17, wherein the executable instructions include instructions that cause the at least one processor to: receive a user prompt; and re-generate the immersive imagery based on the user prompt.
Clause 19. The extended reality device of clause 17 or 18, wherein the executable instructions include instructions that cause the at least one processor to: obtain metadata of the media item from an entity page of the media item; and generate the immersive imagery using a generative model inputted with the metadata.
Clause 20. The extended reality device of any one of clauses 17 to 19, wherein the executable instructions include instructions that cause the at least one processor to: apply a visual effect to the immersive imagery based on the content in the display panel.
Clause 21. A method comprising: rendering a user interface on an extended reality device, the user interface identifying a media item for playback using a streaming application; and in response to selection of the media item for playback: initiating a display of immersive imagery related to the media item on the extended reality device; and transmitting a request to the streaming application, the request including at least one parameter about the immersive imagery that causes the streaming application to render a display panel within the immersive imagery using the at least one parameter, the display panel displaying content of the media item.
Clause 22. The method of clause 21, wherein the at least one parameter includes a curvature value for the display panel, the curvature value being used to configure the display panel within the immersive imagery.
Clause 23. The method of clause 21 or 22, wherein the at least one parameter includes a panel size for the display panel, the panel size being used to configure the display panel within the immersive imagery.
Clause 24. The method of any of clauses 21 to 23, wherein the at least one parameter includes a panel placement parameter indicating a position for positioning the display panel within the immersive imagery.
Clause 25. The method of any of clauses 21 to 24, wherein the at least one parameter includes an inheritance parameter that causes the streaming application to inherit the immersive imagery from a host application associated with the user interface.
Clause 26. The method of any of clauses 21 to 25, wherein the request includes a content identifier associated with the media item, the content identifier configured to cause the streaming application to initiate playback of the media item.
Clause 27. The method of any of clauses 21 to 26, further comprising: in response to selection of the media item, generating the immersive imagery based on metadata associated with the media item.
Clause 28. The method of any of clauses 21 to 27, further comprising: receiving a user prompt; and re-generating the immersive imagery based on the user prompt.
Clause 29. A non-transitory computer-readable medium storing executable instructions that cause at least one processor to execute operations, the operations comprising: rendering a user interface on an extended reality device, the user interface identifying a media item for playback using a streaming application; and in response to selection of the media item for playback: initiating a display of immersive imagery related to the media item on the extended reality device; and transmitting a request to the streaming application, the request including at least one parameter about the immersive imagery that causes the streaming application to render a display panel within the immersive imagery using the at least one parameter, the display panel displaying content of the media item.
Clause 30. The non-transitory computer-readable medium of clause 29, wherein the at least one parameter includes a curvature value for the display panel, the curvature value being used to configure the display panel within the immersive imagery.
Clause 31. The non-transitory computer-readable medium of clause 29 or 30,wherein the at least one parameter includes a panel size for the display panel, the panel size being used to configure the display panel within the immersive imagery.
Clause 32. The non-transitory computer-readable medium of any of clauses 29 to 31, wherein the at least one parameter includes a panel placement parameter indicating a position for positioning the display panel within the immersive imagery.
Clause 33. The non-transitory computer-readable medium of any of clauses 29 to 32, wherein the operations further comprise: in response to selection of the media item, generating the immersive imagery based on metadata associated with the media item.
Clause 34. The non-transitory computer-readable medium of any of clauses 29 to 33, wherein the at least one parameter includes an inheritance parameter that causes the streaming application to inherit the immersive imagery from a host application associated with the user interface.
Clause 35. The non-transitory computer-readable medium of any of clauses 29 to 34, wherein the request includes a content identifier associated with the media item, the content identifier configured to cause the streaming application to initiate playback of the media item.
Clause 36. The non-transitory computer-readable medium of any of clauses 29 to 35, wherein the operations further comprise: applying a visual effect to the immersive imagery based on the content in the display panel.
Clause 37. An extended reality device comprising: at least one processor; and a non-transitory computer-readable medium storing executable instructions that cause the at least one processor to: render a user interface on the extended reality device, the user interface identifying a media item for playback using a streaming application; and in response to selection of the media item for playback: initiate a display of immersive imagery related to the media item on the extended reality device; and transmit a request to the streaming application, the request including at least one parameter about the immersive imagery that causes the streaming application to render a display panel within the immersive imagery using the at least one parameter, the display panel displaying content of the media item.
Clause 38. The extended reality device of clause 37, wherein the at least one parameter includes a curvature value for the display panel, a panel size for the display panel, and an inheritance parameter that causes the streaming application to inherit the immersive imagery from a host application associated with the user interface.
Clause 39. The extended reality device of clause 37 or 38, wherein the at least one parameter includes a panel placement parameter indicating a position for positioning the display panel within the immersive imagery.
Clause 40. The extended reality device of any of clauses 37 to 39, wherein the executable instructions include instructions that cause the at least one processor to: in response to selection of the media item, generate the immersive imagery based on metadata associated with the media item.

In some examples, the system and techniques discussed herein may reduce the amount of computing resources, cost, and/or time required to generate personalized scenes on demand. In some examples, the system and techniques discussed herein generate non-curated generative 360 environments that are themed to video content, based on text metadata (e.g., resource locators, captions, entity pages, and/or descriptions), and, in some examples, based on audio, image, and/or video samples. In some examples, a video resource locator is embedded with a preamble to query a generative model for visual features and a relevant background image. To extend the field of view of the base image, the system may compute the embedding of the base image, generate multiple landscape images conditioned on the computed embedding vector with empty prompt using different scales. As the scale increases, the results may become more reflective of the base image.

In some examples, the system includes a summary caption step, which may increase the accuracy where the video has very little or very complex descriptions (e.g. multiple hashtags but no other descriptive prose). In some examples, a generative model may be relatively accurate by summarizing metadata even in cases where the metadata is limited.

In some examples, the system inputs the 2D image from the language model to an out-painting model along with a related mask and prompt (which is generated from a captioner) to obtain the first extended image. Then, the system may perform another round of out-painting to obtain a further field of view extension in landscape mode.

In some examples, the system uses embedding conditioning. The contrastive embedding of the input images is calculated and is given to the out-painting model alongside the prompt to generate the landscape image. For the input image, the system may use the direct output from the generative model or the output of the first round of out-painting as a reference image. The scale parameter may control the similarity of generated results with respect to the reference image.

In some examples, in the case of a media aggregator application, providing a generative model with the movie title may provide enough information to generate a relatively accurate base image. In some examples, the system may increase the 2D image output quality by augmenting the prompt to include related to lighting, background, style (e.g. contemporary, modern, etc.), and by adjusting the general wording/language used in the prompt.

In some examples, the generative model includes a fine-tuned AR model which generates 360 image panoramas based on direct prompts which can include video metadata (e.g. entity page, title, captions, video description, etc.) and/or image, video, and/or audio samples. In some examples, the immersive imagery engine includes a 2D-to-360 pipeline to convert the 2D image to a 360 panorama image.

In some examples, the system may enable users to select from a set of pre-generated and approved panoramic images personalized by subject, style, and mood. In some examples, the system may receive sample frames from the video to assess the subject and mood of the content, then automatically select from a set of pre-generated and approved panorama images.

In some examples, the system uses a scoring model to determine the quality of the generated 360 panoramas, including prompt alignment, image fidelity (e.g., closeness to the ground truth 2D image, and seam alignment. If quality score does not meet a defined threshold based on these criteria, then the experience may default to the dynamic hue extended screen.

In some examples, a user may use a map application to explore 3D reconstructed scenes of interesting places around the world. The user may navigate the map application to explore downtown San Francisco and may navigate into the 3D scene of a highly recommended restaurant from a street view pano (e.g., a 360-degree panoramic image captured by street view cameras) to navigate through details of the interior.

In some examples, the system may generate 360 degree skybox scenes based on the theme of a video (e.g. if the user is watching Star Wars, then perhaps they see space or planetary skybox imagery). In some examples, the user may enter into an application (e.g., a video sharing application, a media application, or a photos applications), the extended reality device may display a virtual skybox that is themed to the video/photo, taking cues from video/photo metadata and matching color gradients. In some examples, the system may convert the hue of the user's passthrough surroundings to match the color themes of a video. In some examples, a video sharing application or a media application may be launched, and the hue of the passthrough surroundings may automatically adjust to the color themes in a video.

In some examples, the system allows the user to generate novel 360 degree skybox scenes on-demand in home (e.g., a home screen). In the headset, the user may enter the home screen and activate a control to edit a scene prompt. The user may submit a written or verbal prompt, which causes the immersive imagery engine to generate the 360 degree skybox scene. In some examples, the system allows the user to create and see dynamic elements in the skybox scene. In the headset, the user may enter Home and generate a skybox scene using a verbal or written prompt or use a generated 360 skybox while in a video sharing application or a media application.

In a media application or a video sharing application, in some examples, the system may enable the generation of the virtual environment based on free-form user input. For example, the application may receive a written or verbal prompt, which causes the system to generate a free-form virtual environment. The user may adjust or personalize through follow up queries. In some examples, the system may generate a 360 degree skybox scene for a search application based on a theme of a search query. In the headset, the user may launch the search application and enter search, and the system may generate a 360 degree skybox based on the theme of the search query. The user may manually change the skybox image using a written or verbal prompt.

In some examples, the system may enable the user to change specific elements of a 360 skybox. In the headset, the user may enter Home and generate a skybox scene using a verbal or written prompt, and change/adjust specific aspects of the skybox scene (e.g. adjust skybox theme, add a tree, remove body of water, etc.)

In some examples, the system may enable a user to share a 360 degree skybox scene. In the headset, the user may enter Home and generate a skybox scene using a verbal or written prompt, and share the skybox scenes, including prompts, with other users.

In some examples, the system enables a user to create and interact with novel 3D virtual immersive scenes on-demand. In the headset, the user may enter Home and generate a novel 3D virtual immersive scene using a written or verbal prompt, change/adjust specific aspects of the virtual 3D object (e.g. retexture/reskin walls, furniture, etc.), and/or interact with objects in the scene (e.g. move a picture from one wall to another, etc.)

In some examples, the system enables a user to create and interact with novel 3D virtual objects in a real or virtual scene on-demand. In the headset, the user may enter Home and generate a novel 3D virtual object in a real or virtual scene using a written or verbal prompt, change/adjust specific aspects of the virtual 3D object (e.g. retexture/reskin object), and/or interact with the 3D object (e.g. poke object and it moves)

In some examples, the system may enable a user to experience virtual 3D versions of retail items. In the headset, a user may navigate to a partner retail website, click on a 3D enabled shopping item (e.g., a couch, running shoes, etc.), which displays the 3D shopping item in the virtual space. The user can interact with the object (e.g., zoom, rotate in 3D space, etc.) and/or generate novel skins and textures for the item.

In some examples, the system may enable a user to interact with real objects in a scene. In augmented reality mode, the user may view one or more objects in their surrounding scene. The user can change/adjust specific aspects of the real world objects in the scene (e.g., retexture/reskin the user's living room couch to an artist-inspired theme, change the view outside your window to a winter snow scene, etc.).

In some examples, the system may cause the generation and/or rendering of 3D Content (e.g., Neural Radiance Fields (NeRFs), Gaussian Splatting, etc.). In some examples, the system may enable a user to transition into a 3D reconstructed scene from an area view or street view in the map application. In the headset, the user may launch the maps application and enter a street view, transition into a reconstructed scene from the street view (or the area view), exit the scene to the area view or the street view, and navigate the scene by walking around or by teleporting.

In the map application, a user may capture images and/or video of a place, to initiate a 3D reconstruction of the place. In some examples, the extended reality device may obtain still images or a video of the place, which is used by the immersive imagery engine to generate the 3D reconstruction, which may be based on gaussian splatting reconstruction. Then, the extended reality device may display and enable the user to navigate the 3D reconstructed scene in the map application.

In some examples, the system may enable the user to generate and view dynamic elements in a 3D reconstructed scene. In the headset, enter a pre-generated 3D scene and view or create dynamic elements in the scenes (e.g. leaves moving on trees, birds flying overhead, cars/people moving in a street scene, etc.) based on verbal or written prompts.

In some examples, the system may enable the user to update their VR space scene based on a selection of pre-generated scenes of interesting locations. In the headset, the extended reality device may display a selection of pre-generated 3D scenes of interesting locations around the world. The user may select a pre-generated 3D scene and render a scene into their space (e.g., Home, etc.). In some examples, the system may enable the user to edit a captured 3D reconstructed scene. The system may capture a personal 3D scene using the device's headset camera(s) or using a mobile device (e.g., a phone, tablet). Then, the user may submit verbal or written prompts to change/adjust specific aspects of the scene (e.g. retexture/reskin walls, floor, etc.) and/or interact with objects within the scene (e.g. move a couch/table, etc.)

In some examples, the system may enable the user to capture and share 3D reconstructions of my objects. In the headset, the extended reality device may capture objects using the headset's camera(s), and the user may submit verbal or written prompts to change/adjust specific aspects of the object (e.g. retexture/reskin, change dimensions, etc.). The user can interact with objects (e.g. zoom, rotate, etc.). In some examples, the system may enable the user to share 3D reconstructed objects with other users.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are remote from each other and typically interact through a communication network. The relationship of client and server arises by virtue of computer programs running on the respective computers and having a client-server relationship with each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

What is claimed is:

1. A method comprising:
rendering a user interface on an extended reality device, the user interface identifying a media item for playback using a streaming application; and
in response to selection of the media item for playback:
initiating a display of immersive imagery related to the media item on the extended reality device; and
transmitting a request to the streaming application, the request including at least one parameter about the immersive imagery that causes the streaming application to render a display panel within the immersive imagery using the at least one parameter, the display panel displaying content of the media item.

2. The method of claim 1, wherein the at least one parameter includes a curvature value for the display panel, the curvature value being used to configure the display panel within the immersive imagery.

3. The method of claim 1, wherein the at least one parameter includes a panel size for the display panel, the panel size being used to configure the display panel within the immersive imagery.

4. The method of claim 1, wherein the at least one parameter includes a panel placement parameter indicating a position for positioning the display panel within the immersive imagery.

5. The method of claim 1, wherein the at least one parameter includes an inheritance parameter that causes the streaming application to inherit the immersive imagery from a host application associated with the user interface.

6. The method of claim 1, wherein the request includes a content identifier associated with the media item, the content identifier configured to cause the streaming application to initiate playback of the media item.

7. The method of claim 1, further comprising:
in response to selection of the media item, generating the immersive imagery based on metadata associated with the media item.

8. The method of claim 1, further comprising:
receiving a user prompt; and
re-generating the immersive imagery based on the user prompt.

9. A non-transitory computer-readable medium storing executable instructions that cause at least one processor to execute operations, the operations comprising:
rendering a user interface on an extended reality device, the user interface identifying a media item for playback using a streaming application; and
in response to selection of the media item for playback:
initiating a display of immersive imagery related to the media item on the extended reality device; and
transmitting a request to the streaming application, the request including at least one parameter about the immersive imagery that causes the streaming application to render a display panel within the immersive imagery using the at least one parameter, the display panel displaying content of the media item.

10. The non-transitory computer-readable medium of claim 9, wherein the at least one parameter includes a curvature value for the display panel, the curvature value being used to configure the display panel within the immersive imagery.

11. The non-transitory computer-readable medium of claim 9, wherein the at least one parameter includes a panel size for the display panel, the panel size being used to configure the display panel within the immersive imagery.

12. The non-transitory computer-readable medium of claim 9, wherein the at least one parameter includes a panel placement parameter indicating a position for positioning the display panel within the immersive imagery.

13. The non-transitory computer-readable medium of claim 9, wherein the operations further comprise:
in response to selection of the media item, generating the immersive imagery based on metadata associated with the media item.

14. The non-transitory computer-readable medium of claim 9, wherein the at least one parameter includes an inheritance parameter that causes the streaming application to inherit the immersive imagery from a host application associated with the user interface.

15. The non-transitory computer-readable medium of claim 9, wherein the request includes a content identifier associated with the media item, the content identifier configured to cause the streaming application to initiate playback of the media item.

16. The non-transitory computer-readable medium of claim 9, wherein the operations further comprise:
applying a visual effect to the immersive imagery based on the content in the display panel.

17. An extended reality device comprising:
at least one processor; and
a non-transitory computer-readable medium storing executable instructions that cause the at least one processor to:
render a user interface on the extended reality device, the user interface identifying a media item for playback using a streaming application; and
in response to selection of the media item for playback:
initiate a display of immersive imagery related to the media item on the extended reality device; and
transmit a request to the streaming application, the request including at least one parameter about the immersive imagery that causes the streaming application to render a display panel within the immersive imagery using the at least one parameter, the display panel displaying content of the media item.

18. The extended reality device of claim 17, wherein the at least one parameter includes a curvature value for the display panel, a panel size for the display panel, and an inheritance parameter that causes the streaming application to inherit the immersive imagery from a host application associated with the user interface.

19. The extended reality device of claim 17, wherein the at least one parameter includes a panel placement parameter indicating a position for positioning the display panel within the immersive imagery.

20. The extended reality device of claim 17, wherein the executable instructions include instructions that cause the at least one processor to:
in response to selection of the media item, generate the immersive imagery based on metadata associated with the media item.
